(19) United States
(12) Patent Application Publication
(10) Pub. No.: US 2025/0280435 A1
(43) Pub. Date: Sep. 4, 2025

(54) TIME GAP ADJUSTMENT FOR CHANNEL ACCESS PROCEDURE BY USER DEVICES FOR A SIDELINK COMMUNICATION IN AN UNLICENSED SPECTRUM

(71) Applicant: FRAUNHOFER-GESELLSCHAFT ZUR FOERDERUNG DER ANGEWANDTEN FORSCHUNG E.V., Muenchen (DE)

(72) Inventors: Thomas WIRTH, Berlin (DE); Sarun SELVANESAN, Berlin (DE); Baris GOEKTEPE, Berlin (DE); Thomas FEHRENBACH, Berlin (DE); Thomas SCHIERL, Berlin (DE); Cornelius HELLGE, Berlin (DE)

(21) Appl. No.: 19/087,055

(22) Filed: Mar. 21, 2025

Related U.S. Application Data
(63) Continuation of application No. PCT/EP2023/076857, filed on Sep. 28, 2023.

(30) Foreign Application Priority Data
Sep. 29, 2022 (EP) 22198730.8

(51) Int. Cl. H04W 74/00; H04W 92/18

(52) U.S. Cl. CPC H04W 74/002; H04W 92/18

(57) ABSTRACT

A user device, UE, for a wireless communication network, like a 3^{rd} Generation Partnership Project, 3GPP, network, is described. The UE is to perform a sidelink, SL, communication using a channel including resources from an unlicensed spectrum. The UE is to occupy the channel within a channel occupancy time, COT, and share the COT with a further UE, wherein the COT has a first part and a second part, the first part of the COT and the second part of the COT being separated by a guard duration. The UE is to perform a transmission over the SL during the first part of the COT. The second part of the COT is used by the further UE to perform a transmission over the SL. The UE is to extend the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

### CROSS-REFERENCES TO RELATED APPLICATIONS

This application is a continuation of copending International Application No. PCT/EP2023/076857, filed Sep. 28, 2023, which is incorporated herein by reference in its entirety, and additionally claims priority from European Application No. EP 22 198 730.8, filed Sep. 29, 2022, which is incorporated herein by reference in its entirety.

The present invention concerns the field of wireless communication systems or networks, more specifically, a direct communication between user devices over a sidelink using resources in the unlicensed spectrum, also referred to as SL-U. Embodiments concern a time gap adjustment for a channel access procedure, CAP, by user devices for a sidelink communication in an unlicensed spectrum.

### BACKGROUND OF THE INVENTION

FIG. 1 is a schematic representation of an example of a terrestrial wireless network 100 including, as is shown in FIG. 1A, the core network 102 and one or more radio access networks RAN₁, RAN₂, . . . . RAN_{N}. FIG. 1B is a schematic representation of an example of a radio access network RANₙ that may include one or more base stations gNB₁ to gNB₅, each serving a specific area surrounding the base station schematically represented by respective cells 106₁ to 106₅. The base stations are provided to serve users within a cell.

The one or more base stations may serve users in licensed and/or unlicensed bands. The term base station, BS, refers to a gNB in 5G networks, an eNB in UMTS/LTE/LTE-A/LTE-A Pro, or just a BS in other mobile communication standards. A user may be a stationary device or a mobile device. The wireless communication system may also be accessed by mobile or stationary IoT devices which connect to a base station or to a user. The mobile or stationary devices may include physical devices, ground based vehicles, such as robots or cars, aerial vehicles, such as manned or unmanned aerial vehicles, UAVs, the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANₙ may include more or less such cells, and RANₙ may also include only one base station. FIG. 1B shows two users UE₁ and UE₂, also referred to as user device or user equipment, that are in cell 106₂ and that are served by base station gNB₂. Another user UE₃ is shown in cell 106₄ which is served by base station gNB₄. The arrows 108₁, 108₂ and 108₃ schematically represent uplink/downlink connections for transmitting data from a user UE₁, UE₂ and UE₃ to the base stations gNB₂, gNB₄ or for transmitting data from the base stations gNB₂, gNB₄ to the users UE₁, UE₂, UE₃. This may be realized on licensed bands or on unlicensed bands. Further, FIG. 1B shows two further devices 110₁ and 110₂ in cell 106₄, like IoT devices, which may be stationary or mobile devices. The device 110₁ accesses the wireless communication system via the base station gNB₄ to receive and transmit data as schematically represented by arrow 112₁. The device 110₂ accesses the wireless communication system via the user UE₃ as is schematically represented by arrow 112₂. The respective base station gNB₁ to gNB₅ may be connected to the core network 102, e.g., via the S1 interface, via respective backhaul links 114₁ to 114₅, which are schematically represented in FIG. 1B by the arrows pointing to “core”. The core network 102 may be connected to one or more external networks. The external network may be the Internet, or a private network, such as an Intranet or any other type of campus networks, e.g., a private WiFi communication system or a 4G or 5G mobile communication system. Further, some or all of the respective base station gNB₁ to gNB₅ may be connected, e.g., via the S1 or X2 interface or the XN interface in NR, with each other via respective backhaul links 116₁ to 116₅, which are schematically represented in FIG. 1B by the arrows pointing to “gNBs”. A sidelink channel allows direct communication between UEs, also referred to as device-to-device, D2D, communication. The sidelink interface in 3GPP is named PC5.

For data transmission a physical resource grid may be used. The physical resource grid may comprise a set of resource elements to which various physical channels and physical signals are mapped. For example, the physical channels may include the physical downlink, uplink and sidelink shared channels, PDSCH, PUSCH, PSSCH, carrying user specific data, also referred to as downlink, uplink and sidelink payload data, the physical broadcast channel, PBCH, and the physical sidelink broadcast channel, PSBCH, carrying for example a master information block, MIB, and one or more system information blocks, SIBs, one or more sidelink information blocks, SLIBs, if supported, the physical downlink, uplink and sidelink control channels, PDCCH, PUCCH, PSSCH, carrying for example the downlink control information, DCI, the uplink control information, UCI, and the sidelink control information, SCI, and physical sidelink feedback channels, PSFCH, carrying feedback responses over PC5. The sidelink interface may support a 2-stage SCI which refers to a first control region containing some parts of the SCI, also referred to as the 1^{st}-stage SCI, and optionally, a second control region which contains a second part of control information, also referred to as the 2^{nd}-stage SCI.

For the uplink, the physical channels may further include the physical random-access channel, PRACH or RACH, used by UEs for accessing the network once a UE synchronized and obtained the MIB and SIB. The physical signals may comprise reference signals or symbols, RS, synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 OFDM symbols depending on the cyclic prefix, CP, length. A frame may also have a smaller number of OFDM symbols, e.g., when utilizing shortened transmission time intervals, sTTI, or a mini-slot/non-slot-based frame structure comprising just a few OFDM symbols.

The wireless communication system may be any single-tone or multicarrier system using frequency-division multiplexing, like the orthogonal frequency-division multiplexing, OFDM, system, the orthogonal frequency-division multiple access, OFDMA, system, or any other Inverse Fast Fourier Transform, IFFT, based signal with or without Cyclic Prefix, CP, e.g., Discrete Fourier Transform-spread-OFDM, DFT-s-OFDM. Other waveforms, like non-orthogonal waveforms for multiple access, e.g., filter-bank multicarrier, FBMC, generalized frequency division multiplexing, GFDM, or universal filtered multi carrier, UFMC, may be used. The wireless communication system may operate, e.g., in accordance with 3GPPs LTE, LTE-Advanced, LTE-Advanced Pro, or the 5G or 3GPPs NR, New Radio, or within NR-U, New Radio Unlicensed, which is specified within the LTE and within NR specifications.

The wireless network or communication system depicted in FIG. 1 may be a heterogeneous network having distinct overlaid networks, e.g., a network of macro cells with each macro cell including a macro base station, like base station gNB₁ to gNB₅, and a network of small cell base stations, not shown in FIG. 1, like femto or pico base stations. In addition to the above-described terrestrial wireless network also non-terrestrial wireless communication networks, NTN, exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro or 5G or NR, New Radio.

In mobile communication networks, for example in a network like that described above with reference to FIG. 1, like a LTE or 5G/NR network, there may be UEs that communicate directly with each other over one or more sidelink, SL, channels, e.g., using the PC5/PC3 interface or WiFi direct. UEs that communicate directly with each other over the sidelink may include vehicles communicating directly with other vehicles, V2V communication, vehicles communicating with other entities of the wireless communication network, V2X communication, for example roadside units, RSUs, roadside entities, like traffic lights, traffic signs, or pedestrians. An RSU may have a functionality of a BS or of a UE, depending on the specific network configuration. Other UEs may not be vehicular related UEs and may comprise any of the above-mentioned devices. Such devices may also communicate directly with each other, D2D communication, using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are necessarily outside one of the cells depicted in FIG. 1, rather, it means that these UEs
may not be connected to a base station, for example, they are not in an RRC connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

FIG. 2A is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X. Thus, in Mode 1, a SL UE, e.g., UE 202 is connected via Uu interface to the gNB, and the gNB coordinates the resources for UE 202 be used to transmit control and/or data to another UE, e.g., UE 204, via a SL interface, which is referred to in NR as PC5.

FIG. 2B is a schematic representation of an out-of-coverage scenario in which the UEs directly communicating with each other are either not connected to a base station, although they may be physically within a cell of a wireless communication network, or some or all of the UEs directly communicating with each other are connected to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 2B which is the out-of-coverage scenario does not necessarily mean that the respective mode 2 UEs in NR or mode 4 UEs in LTE are outside of the coverage 200 of a base station, rather, it means that the respective mode 2 UEs in NR or mode 4 UEs in LTE are not served by a base station, are not connected to the base station of the coverage area, or are connected to the base station but receive no SL resource allocation configuration or assistance from the base station. 25 Thus, there may be situations in which, within the coverage area 200 shown in FIG. 2A, in addition to the NR mode 1 or LTE mode 3 UEs 202, 204 also NR mode 2 or LTE mode 4 UEs 206, 208, 210 are present. In addition, FIG. 2B, schematically illustrates an out of coverage UE using a relay to communicate with the network. For example, the UE 210 may communicate over the sidelink with UE 212 which, in turn, may be connected to the gNB via the Uu interface. Thus, UE 212 may relay information between the gNB and the UE 210. Thus, the SL UEs, e.g., UEs 206-210, need not to have a connectivity to the gNB, and perform a sensing & access resource allocation or a random access-based resource allocation, e.g., when transmitting from UE 206 to UE 208. Nevertheless, basic configurations need to be available for the UEs 206-210, in order to successfully exchange 35 data. This information may be pre-configured or may be configured while a UE is within coverage of the gNB. For this the gNB may provide a basic configuration, e.g., basic information, which may be transported via a broadcast channel, e.g., using system information blocks (SIBs). The BS may also assist Mode 2 UEs to provide basic information on which resource pool (RP) is to be used or may act as a synchronization source.

Although FIG. 2A and FIG. 2B illustrate vehicular UEs, it is noted that the described in-coverage and out-of-coverage scenarios also apply for non-vehicular UEs. In other words, any UE, like a hand-held device, communicating directly with another UE using SL channels may be in-coverage and out-of-coverage.

In the above-described scenarios of vehicular user devices, UEs, a plurality of such user devices may form a user device group, also referred to simply as group, and the communication within the group or among the group members may be performed via the sidelink interfaces between the user devices, like the PC5 interface. For example, the above-described scenarios using vehicular user devices may be employed in the field of the transport industry in which a plurality of vehicles being equipped with vehicular user devices may be grouped together, for example, by a remote driving application. Other use cases in which a plurality of user devices may be grouped together for a sidelink communication among each other include, for example, factory automation and electrical power distribution. In the case of factory automation, a plurality of mobile or stationary machines within a factory may be equipped with user devices and grouped together for a sidelink communication, for example for controlling the operation of the machine, like a motion control of a robot. In the case of electrical power distribution, entities within the power distribution grid may be equipped with respective user devices which, within a certain area of the system may be grouped together so as to communicate via a sidelink communication with each other so as to allow for monitoring the system and for dealing with power distribution grid failures and outages.

It is noted that the information in the above section is only for enhancing the understanding of the background of the invention and, therefore, it may contain information that does not form conventional technology that is already known to a person of ordinary skill in the art.

Starting from the above, there may be a need for improvements or enhancements of the sidelink in a wireless communication system or network.

### SUMMARY

An embodiment may have a user device, UE, for a wireless communication network, like a 3^{rd} Generation Partnership Project, 3GPP, network, wherein the UE is to perform a sidelink, SL, communication using a channel comprising resources from an unlicensed spectrum, wherein the UE is to occupy the channel within a channel occupancy time, COT, and share the COT with a further UE, wherein the COT has a first part and a second part, the first part of the COT and the second part of the COT being separated by a guard duration, wherein the UE is to perform a transmission over the SL during the first part of the COT, wherein the second part of the COT is used by the further UE to perform a transmission over the SL, and wherein the UE is to extend the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

Another embodiment may have a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises: occupying the channel within a channel occupancy time, COT, sharing the COT with a further UE, wherein the COT has a first part and a second part, the first part of the COT and the second part of the COT being separated by a guard duration, performing a transmission over the SL during the first part of the COT, wherein the second part of the COT is used by the further UE to perform a transmission over the SL, and extending the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

Another embodiment may have a non-transitory digital storage medium having a computer program stored thereon to perform the method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises: occupying the channel within a channel occupancy time, COT, sharing the COT with a further UE, wherein the COT has a first part and a second part, the first part of the COT and the second part of the COT being separated by a guard duration, performing a transmission over the SL during the first part of the COT, wherein the second part of the COT is used by the further UE to perform a transmission over the SL, and extending the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT, when said computer program is run by a computer.

### BRIEF DESCRIPTION OF THE DRAWINGS

Embodiments of the present invention will be detailed subsequently referring to the appended drawings, in which:

FIG. 1A is a schematic representation of an example of a terrestrial wireless network;

FIG. 1B is a schematic representation of an example of a radio access network RANₙ;

FIG. 2A is a schematic representation of an in-coverage scenario;

FIG. 2B is a schematic representation of an out-of-coverage scenario;

FIG. 3A illustrates a first example for sidelink time slot formats such as a time slot format having one guard symbol;

FIG. 3B illustrates a second example for sidelink time slot formats such as a time slot format having two guard symbols;

FIG. 4 is a schematic representation of a wireless communication system including a transmitter, like a base station, and one or more receivers, like user devices, UEs, implementing embodiments of the present invention;

FIG. 5 illustrates a wireless communication system including user devices and a base station in accordance with embodiments of the present invention;

FIG. 6 illustrates a channel occupied by a first UE within a COT which shares the COT with a second UE, the first UE extending, in accordance with embodiments of the present invention, its transmission into a guard duration between two parts of the COT;

FIG. 7 illustrates a channel occupied by a first UE within a COT which shares the COT with a second UE, the second UE extending, in accordance with embodiments of the present invention, its transmission into a guard duration between two parts of the COT;

FIG. 8 illustrates a channel occupied by a first UE within a COT which shares the COT with a second UE, the first and second UEs extending, in accordance with embodiments of the present invention, their transmissions into a guard duration between two parts of the COT;

FIG. 9A illustrates a channel which is occupied by a COT initiating UE and comprises two time slots having a structure as in FIG. 3A separated by a guard symbol;

FIG. 9B illustrates the channel of FIG. 9A with a transmission of the initiating UE extended in to the guard symbol in accordance with embodiments of the present invention;

FIG. 9C illustrates the channel of FIG. 9A with a transmission of a responding UE extended in to the guard symbol in accordance with embodiments of the present invention;

FIG. 10A illustrates one embodiment of the present invention assuming a COT to have a duration of one time slot having a structure as in FIG. 3B;

FIG. 10B illustrates another embodiment of the present invention assuming a COT to have a duration of one time slot having a structure as in FIG. 3B;

FIG. 11A illustrates one embodiment of the present invention assuming a COT to have a duration of a first time slot having a structure as in FIG. 3B and at least one following time slot having a structure as in FIG. 3A or in FIG. 3B;

FIG. 11B illustrates another embodiment of the present invention assuming a COT to have a duration of a first time slot having a structure as in FIG. 3B and at least one following time slot having a structure as in FIG. 3A or in FIG. 3B;

FIG. 12A illustrates one embodiment of the present invention in accordance with which transmissions from both an initiating UE and a responding UE are extended into the guard symbol between a first time slot having a structure as in FIG. 3B and at least one following time slot having a structure as in FIG. 3A or in FIG. 3B;

FIG. 12B illustrates another embodiment of the present invention in accordance with which transmissions from both an initiating UE and a responding UE are extended into the guard symbol between a first time slot having a structure as in FIG. 3B and at least one following time slot having a structure as in FIG. 3A or in FIG. 3B; and

FIG. 13 illustrates an example of a computer system on which units or modules as well as the steps of the methods described in accordance with the inventive approach may execute.

### DETAILED DESCRIPTION OF THE INVENTION

Embodiments of the present invention are now described in more detail with reference to the accompanying drawings, in which the same or similar elements have the same reference signs assigned.

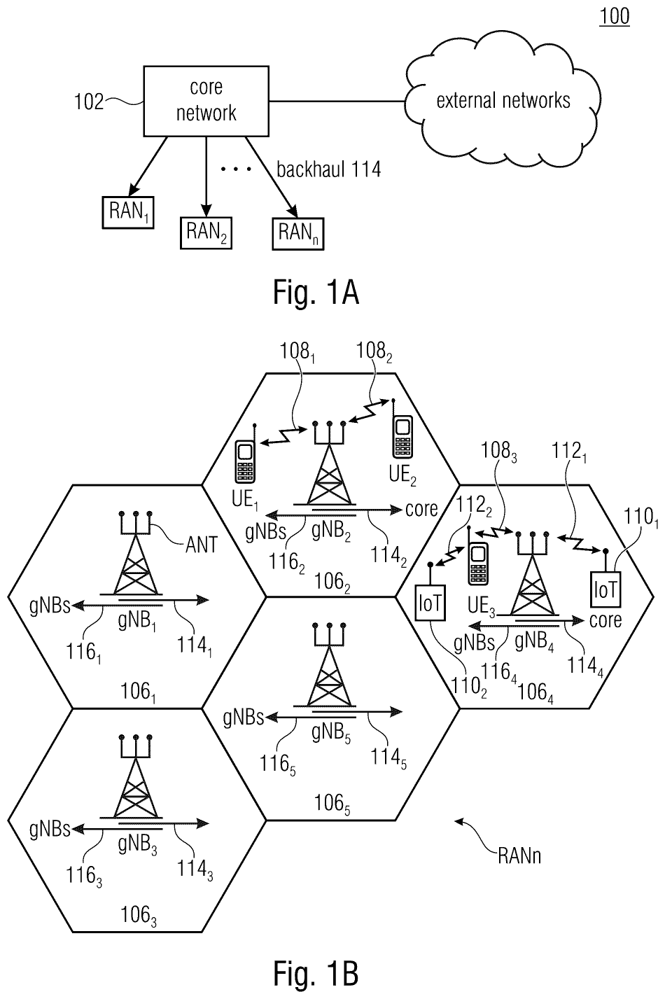

In mobile communication systems or networks, like those described above with reference to FIG. 1, for example in an LTE or 5G/NR network, the respective entities may communicate using one or more frequency bands. A frequency band includes a start frequency, an end frequency and all intermediate frequencies between the start and end frequencies. In other words, the start, end and intermediate frequencies may define a certain bandwidth, e.g., 20 MHz. A frequency band may also be referred to as a carrier or subcarrier, a bandwidth part, BWP, a subband, a subchannel, and the like.

When using a single frequency band, the communication may be referred to as a single-band operation, e.g., a UE transmits/receives radio signals to/from another network entity on frequencies being within the band, like the 20 MHz band.

When using a two or more frequency bands, the communication may be referred to as a multi-band operation or as a wideband operation or as a carrier aggregation operation. The frequency bands may have different bandwidths or the same bandwidth, like 20 MHz. For example, in case of frequency bands having the same bandwidths a UE may transmit/receive radio signals to/from another network entity on frequencies being within two or more of the 20 MHz bands so that the frequency range for the radio communication may be a multiple of 20 MHz. The two or more frequency bands may be continuous/adjacent frequency bands or some or all for the frequency bands may be separated in the frequency domain.

The multi-band operation may include frequency bands in the licensed spectrum, or frequency bands in the unlicensed spectrum, or frequency bands both in the licensed spectrum and in the unlicensed spectrum.

Carrier aggregation, CA, is an example using two or more frequency bands in the licensed spectrum and/or in the unlicensed spectrum. Also mixed combinations are possible, e.g., one or more frequency bands in licensed and one or more frequency bands in unlicensed bands. Furthermore, CA may also be just used for aggregation of an additional carrier in one direction, e.g., as a supplemental carrier to improve transmissions via UL, DL or SL.

5G New Radio (NR) may support an operation in the unlicensed spectrum so that a single-band operation or a multi-band operation may include frequency bands or subbands in the unlicensed spectrum. The unlicensed spectrum may include bands with a potential IEEE 802.11 coexistence, such as frequency bands within the 5 GHZ and/or the 6 GHz spectrum. NR-U may support bandwidths that are an integer multiple of 20 MHZ, for example due to regulatory requirements. The splitting into the subbands may be performed so as to minimize interference with coexisting systems, like IEE 802.11 systems, which may operate in one or more of the same bands with the same nominal bandwidth channels, like 20 MHz channels. Other examples, of coexisting systems may use subbands having subband sizes and nominal frequencies different from the above-described IEEE 802.11 systems. For example, the unlicensed spectrum may include the 5 GHz band, the 6 GHz band, the 24 GHz band or the 60 GHz band. Examples of such unlicensed bands include the industrial, scientific and medical, ISM, radio bands reserved internationally for the use of radio frequency energy for industrial, scientific and medical purposes other than telecommunications.

During an operation using unlicensed subbands, Listen-before-talk, LBT, may be performed separately per subband. This may lead to a situation in which one or more of the subbands are busy or occupied due to an interference, for example, from other communication systems coexisting on the same band, like other public land mobile networks, PLMNs or systems operating in accordance with the IEEE 802.11 specification or operating under the ETSI Broadband Radio Access Networks, BRAN, specifications. In such a situation, the transmitter, either the transmitting gNB or the transmitting UE, is only allowed to transmit on the subbands which are detected to be not busy, also referred to as subbands being free or non-occupied. For example, for a transmission spanning more than 20 MHz in the 5 GHz operational unlicensed band, the transmitter, like the gNB or the UE, performs Listen-Before-Talk, LBT, separately on each subband. Once the LBT results are available for each subband, the devices, for example, the gNB in the downlink, DL, or the UE in the uplink, UL, are allowed to transmit on those subbands which are determined to be free or unoccupied, i.e., to transmit on the won subband(s). No transmission is allowed on the occupied, busy, or non-won subbands.

For accessing resources or channels in the unlicensed spectrum, a so-called NR-U channel access is to be performed, which makes use of a channel access procedure, which is a procedure based on sensing that evaluates the availability of a channel for performing transmissions. The basic unit for sensing may be a sensing slot with a certain duration, e.g., Tₛₜ=9 μs. The sensing slot duration Tₛₜ is considered to be idle if a base station or a UE senses the channel during the sensing slot duration and determines that the detected power is less than an energy detection threshold for at least a certain time, like 4 μs. within the sensing slot duration. Otherwise, the sensing slot duration is considered to be busy. In case a channel is available or not busy, one or more transmission may be performed on the channel, and the so-called channel occupancy refers to the one or more transmissions on the one or more channels by the base station or UE after performing the corresponding channel access procedure. A channel occupancy time, COT, refers to the total time for which the base station or UE and any other base station or UE may share the channel occupancy to perform one or more transmissions on the channel after the base station or UE has performed the channel access procedure, CAP.

For determining a channel occupancy time, if a transmission gap is less than or equal to a certain period, like 25 μs, the gap duration is counted in the channel occupancy time. A channel occupancy time may be shared for a transmission between a base station and a corresponding UE.

Several types of channel access procedures, CAPs, may exist, e.g.:
Type-1 CAP The time duration for which the sensed channel has be idle before the transmission may be random. For example, a base station or a UE may determine an initial counter N which is randomly selected to be between 0 and CWₚ, where CW_{min,p}≤CWₚ≤CW_{max,p}, with CW_{min,p} and CW_{max,p} being subject to the channel access procedure class, CAPC. When the channel is sensed to be idle for a certain period of time, the value of N is decreased, and a transmission may take place only once N reaches 0.
Type-2A: The time duration for which the sensed channel has be idle before the transmission may be deterministic, and the channel may need to be idle for two sensing slots (e.g. at the beginning and end) within a sensing interval of a first duration, like 25 μs.
Type-2B: The time duration for which the sensed channel has be idle before the transmission may be deterministic, and the channel may need to be idle for one sensing slot within a sensing interval of a second duration shorter than the first duration, like 16 μs.
Type-2C: This type does not perform any sensing of the channel before the transmission, and the duration of a corresponding transmission may have a predefined duration, e.g., may be at most 584 μs. This may also be referred to as a LBT-less CAP.

Once a UE has performed the channel access procedure, CAP, the UE occupies the given band or channel in which it performed the LBT and the COT begins. The UE is also referred to as the initiating UE. It is also possible for the initiating UE to share the COT with another gNB or with another UE, also referred to as the responding UE, in the case of a sidelink communication, SL-U, using resources from an unlicensed spectrum, like an unlicensed SL resource pool, SL-U RP, including a plurality of resources from an unlicensed spectrum to be used for SL transmissions. For a sidelink communication, SL-U, using the unlicensed spectrum, when an initiating UE shares the COT with another or responding UE, also referred to as UE-to-UE COT sharing, despite the fact that the responding UE uses the shared COT for which the initiating UE has already performed a CAP, like an LBT, it is required for the responding UE to check the availability of the shared channel using a CAP. The CAP employed by the responding UE may be shorter than the CAP employed by the initiating UE, for example a shorter LBT, such as the above-referenced Type-2A or Type-2B CAPs. In case the responding UE transmits a feedback, like a PSFCH, which may be categorized as a short transmission since the feedback spans only two or three symbols, the UE may also perform Type-2C CAP without carrying out any LBT. For the UE-to-UE COT sharing, the following may apply for the above-mentioned Type 2A/2B/2C channel access procedures:
The Type 2A channel access procedure may be applicable to one or more transmissions by a UE following one or more transmissions by another UE for a gap ≥25 μs in the shared channel occupancy.
The Type 2B channel access procedure may be applicable to one or more transmissions by a UE following one or more transmissions by another UE for a gap ≥16 μs in the shared channel occupancy.
The Type 2C channel access procedure may be applicable to one or more transmissions by a UE following one or more transmissions by another UE for a gap ≤16 μs in a shared channel occupancy and a duration of a transmission being at most 584 μs.

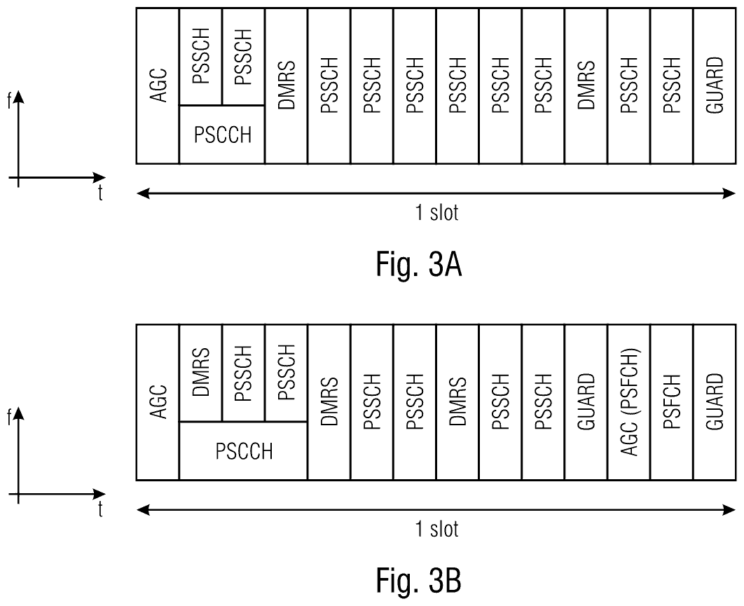

For a communication using the sidelink, the respective entities, like the SL-UEs, may employ a sidelink frame structure as shown in FIG. 3, which illustrates two examples for time slot formats. FIG. 3A illustrates a time slot format having one guard symbol, and FIG. 3B illustrates time slot format having two guard symbols. As may be seen from FIG. 3A, the time slot includes 14 symbols. A first symbol is an automatic gain control, AGC, symbol followed by two symbols carrying both the PSCCH and the PSSCH. The fourth symbol is a Demodulation Reference Signal, DMRS, symbol followed by six PSSCH symbols and a further DMRS symbol. The twelfth and thirteenth symbols are also PSSCH symbols and the last symbol is the guard symbol. FIG. 3B illustrates a time slot format in which, again, the first symbol is the AGC symbol followed by three symbols shared by the DMRS, the PSCCH and the PSSCH. The fifth symbol is a DMRS symbol followed by two PSSCH symbols again followed by a further DMRS symbol which, in turn, is followed by two PSSCH symbols. The eleventh symbol is a guard symbol followed by a further AGC symbol for the PSFCH which is transmitted in the thirteenth symbol followed by a further guard symbol.

The time slot format in accordance with FIG. 3A may be used when transmitting/receiving payload data with feedback disabled, for example, for blind transmissions. FIG. 3B illustrates a time slot format which may be used in case a feedback for a transmission from a receiver is to be provided using the PSFCH symbol. Thus, the sidelink frame structure illustrated in FIG. 3 includes at least one guard symbol which is used by a UE to switch from a transmitting, TX, mode to a receiving, RX, mode and vice versa. For example, the time slot according to FIG. 3A may be used by a first UE for sending a transmission and the last symbol, the guard symbol, is used by the first UE so as to switch from the TX mode to the RX mode, for example for receiving a transmission in a subsequent slot from another UE. In FIG. 3B, a first UE may transmit the payload data and switch in the first guard symbol from the TX mode to the RX mode so as to receive in the twelfth and thirteenth symbol a feedback. While the duration of the guard symbol is across one OFDM symbol, as illustrated in FIG. 3, the actual duration in time may vary depending on the subcarrier spacing, SCS. The actual time needed for a UE to switch between the TX and RX modes in case of a single component carrier, CC, using a CP-OFDM waveform and at least 10 resource blocks, i.e., the AGC setting time, may be as follows:
35 μs for a 15 kHz SCS,
35 μs for a 30 KHz SCS,
18 μs for a 60 KHz SCS.

During the guard symbols, a UE neither transmits nor receives anything, and the guard symbol, as illustrated in FIG. 3, may occur at the end of the time slot or before the symbols used for the PSFCH as this sending of the PSFCH in the same time slot requires the UE to switch between transmission/reception modes. Within the slots that may be used for the PSSCH transmission, there may be 7 to 14 of the slots reserved for a sidelink operation, among which the PSSCH may be transmitted in 5 to 12 symbols. The remaining sidelink symbols may transmit some or all of the control information, like the PSCCH, the PSFCH, reference symbols, like DMRS, the AGC and the guard symbols.

As mentioned, the time duration of each symbol within a time slot depends on the numerology used to define, for example, the sidelink bandwidth part within which the sidelink resource pool is configured, and this time duration is used for determining the length of the guard symbol as is shown in the table below which indicates for certain numerologies and SCSs the corresponding time durations of one symbol in a time slot.

| | | | |
|---|---|---|---|
| Parameter/Numerology (μ) | 0 | 1 | 2 |
| Subcarrier Spacing (kHz) | 15 | 30 | 60 |
| OFDM Symbol Duration (μs) | 66.67 | 33.33 | 16.67 |
| Cyclic Prefix Duration (μs) | 4.69 | 2.34 | 1.17 |
| OFDM Symbol including CP (μs) | 71.35 | 35.68 | 17.84 |

When considering the above described sidelink frame structures including at least one guard symbol, it has been found that, while the guard symbol is sufficient for allowing responding UE to perform the required CAP before starting its transmission so as to make sure that the channel, during the shared COT, is available for the transmission to be performed by the responding UE, at the same time, the time duration of the guard symbol, which is a duration in which neither of the initiating UE nor the responding UE transmit, is sufficient to allow another device to perform a channel access procedure, for example a device of another 3GPP wireless communication system or a device of a wireless communication system using a different RAT, like a WiFi device or a Bluetooth device, so that the shared channel may be taken over by such a device and occupied so that COT sharing is no longer possible.

The present invention addresses the above problem and, in accordance with embodiments, provides an approach reducing the likelihood or fully avoiding that a channel is taken over during the COT by a different device performing a successful CAP during the time duration of the guard symbol. Embodiments of the present invention solve the above mentioned problem by configuring the time gap between the transmissions by an initiating UE and by a responding UE such that the time gap, i.e., the time during which neither one of the UEs transmits, is small enough so that no other device, like no other 3GPP device or non-3GPP device, is capable to occupy the channel during the shared COT, while at the same time, the time gap is long enough for the responding UE to perform a channel access procedure, like an LBT, or a LBT-less CAP before accessing the shared COT. Considering the above described time slot structures defined for the sidelink communication, in accordance with embodiments, the time gap defined by the guard symbol or the guard is adjusted such that taking over the channel during the shared COT is less likely or even not possible at all.

The inventive approach is advantageous as it allows the responding UE to perform at least a shortened CAP, like the above described Type-2 channel access procedures, before using the shared COT while, at the same time, the guard symbol is no longer long enough for other devices to occupy the channel. The basic structure of the time slot, like the structure as described above with reference to FIG. 3, remains unchanged, however, in accordance with the inventive approach at least a part of the guard symbol appears, to another device, like another 3GPP device or a non-3GPP device, performing its CAP, to be busy or occupied. Thus, given the fact that the CAP to be applied by the other device requires a time duration spanning the majority of the guard symbol in most cases, the likelihood of another device considering the guard symbol to be actually idle is substantially reduced. In accordance with certain embodiments, the time duration may actually span the entire or almost the entire duration of the guard symbol so that any attempts by another device to occupy the channel, thereby interrupting the COT sharing, are basically prevented.

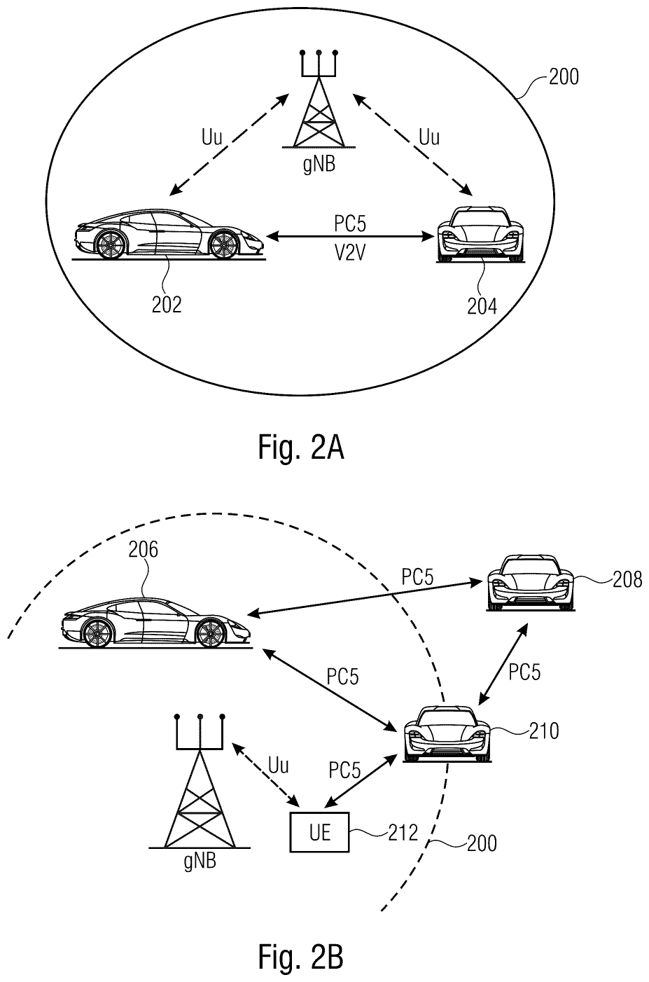

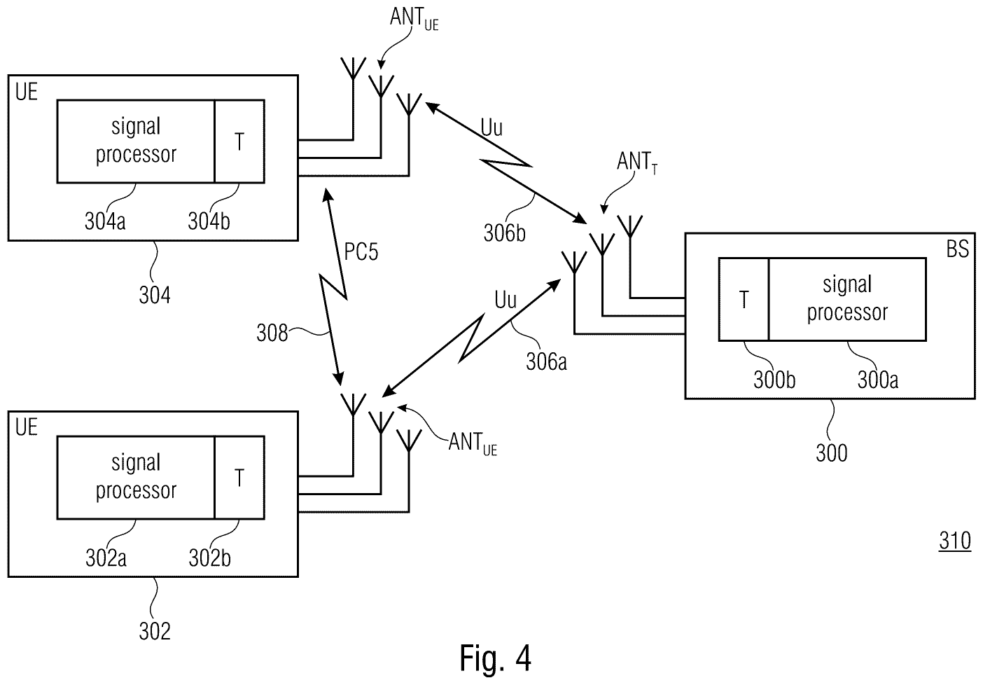

Embodiments of the present invention may be implemented in a wireless communication system as depicted in FIG. 1, FIG. 2A or FIG. 2B including base stations and users, like mobile terminals or IoT devices. FIG. 4 is a schematic representation of a wireless communication system including a transmitter 300, like a base station, and one or more receivers 302, 304, like user devices, UEs. The transmitter 300 and the receivers 302, 304 may communicate via one or more wireless communication links or channels 306a, 306b, 308, like a radio link. The transmitter 300 may include one or more antennas ANT_{T} or an antenna array having a plurality of antenna elements, a signal processor 300a and a transceiver 300b, coupled with each other. The receivers 302, 304 include one or more antennas ANT_{UE} or an antenna array having a plurality of antennas, a signal processor 302a, 304a, and a transceiver 302b, 304b coupled with each other. The base station 300 and the UEs 302, 304 may communicate via respective first wireless communication links 306a and 306b, like a radio link using the Uu interface, while the UEs 302, 304 may communicate with each other via a second wireless communication link 308, like a radio link using the PC5 or sidelink, SL, interface. When the UEs are not served by the base station or are not connected to the base station, for example, they are not in an RRC connected state, or, more generally, when no SL resource allocation configuration or assistance is provided by a base station, the UEs may communicate with each other over the sidelink. The system or network of FIG. 4, the one or more UEs 302, 304 of FIG. 4, and the base station 300 of FIG. 4 may operate in accordance with the inventive teachings described herein.

UE initiating COT

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to occupy the channel within a channel occupancy time, COT, and share the COT with a further UE, wherein the COT has a first part and a second part, the first part of the COT and the second part of the COT being separated by a guard duration,
wherein the UE is to perform a transmission over the SL during the first part of the COT,
wherein the second part of the COT is used by the further UE to perform a transmission over the SL, and
wherein the UE is to extend the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

In accordance with embodiments, the UE is to extend the transmission into the guard duration by taking or copying content from a predefined portion of the first part of the COT or the first part of the transmission, e.g., from a beginning of a last transmission symbol following a cyclic prefix, CP, or an extended cyclic prefix of data in the last transmission symbol.

In accordance with embodiments, the last transmission symbol contains one or more of:
an Automatic Gain Control, AGC, symbol,
a Demodulation Reference Signal, DMRS,
a data channel, e.g., a Physical Sidelink Shared Channel, PSSCH,
a control channel, e.g., a Physical Sidelink Control Channel, PSCCH,
a feedback channel, e.g. a Physical Sidelink Feedback Channel, PSFCH.

### UE Sharing COT

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to share a channel occupied by a further UE during a channel occupancy time, COT, initiated by the further UE, wherein the COT has a first part and a second part, the first part of the COT and the second part of the COT being separated by a guard duration,
wherein the first part of the COT is used by the further UE to perform a transmission over the SL,
wherein the UE is to perform a transmission over the SL during the second part of the COT, the first part of the COT and the second part of the COT being separated by a guard duration, and
wherein the UE is to extend the transmission into the guard duration so as to transmit during a predefined time duration ending at an end of the guard duration, the predefined time duration selected such that an initial duration of the guard duration is sufficient to allow the UE to perform a predefined channel access procedure, CAP, before accessing the shared COT.

In accordance with embodiments, the UE is to extend the transmission into the guard duration by taking or copying content from a predefined portion of the second part of the COT or last part of the transmission, e.g., from an end of the next symbol.

In accordance with embodiments, the next symbol contains one or more of:
an Automatic Gain Control, AGC, symbol,
a Demodulation Reference Signal, DMRS,
a data channel, e.g., a Physical Sidelink Shared Channel, PSSCH,
a control channel, e.g., a Physical Sidelink Control Channel, PSCCH,
a feedback channel, e.g. a Physical Sidelink Feedback Channel, PSFCH,
an Automatic Gain Control, AGC, symbol prior to the PSFCH.

In accordance with embodiments, the next symbol from which the content is copied belongs to the same time slot or to the next time slot.

The present invention provides a user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to share a channel occupied by a further UE during a channel occupancy time, COT, initiated by the further UE, wherein the COT has a first part and a second part, the first part of the COT and the second part of the COT being separated by a guard duration,
wherein the first part of the COT is used by the further UE to perform a transmission over the SL, the further UE extending the transmission into the guard duration so as to transmit during a first predefined time duration starting at the beginning of the guard duration, and
wherein the UE is to perform a transmission over the SL during the second part of the COT, the UE extending the transmission into the guard duration so as to transmit during a second predefined time duration ending at an end of the guard duration.

In accordance with embodiments, the UE is to access the shared COT without performing a Listen-Before-Talk, LBT, procedure before accessing the shared COT.

In accordance with embodiments, one of the first or second predefined time durations is zero so that one of the UE or the further UE occupies the whole guard period.

In accordance with embodiments,
the further UE is to extend the transmission into the guard duration by taking or copying content from a predefined portion of the first part of the COT or the first part of the transmission, e.g., from a beginning of a last transmission symbol following a cyclic prefix or extended cyclic prefix of data in the last transmission symbol, and/or
the UE is to extend the transmission into the guard duration by taking or copying content from a predefined portion of the second part of the COT or last part of the transmission, e.g., from an end of the next symbol, like an Automatic Gain Control, AGC, symbol.

In accordance with embodiments, the last transmission symbol or the next symbol contains one or more of:
an Automatic Gain Control, AGC, symbol,
a Demodulation Reference Signal, DMRS,
a data channel, e.g., a Physical Sidelink Shared Channel, PSSCH,
a control channel, e.g., a Physical Sidelink Control Channel, PSCCH
a feedback channel, e.g. a Physical Sidelink Feedback Channel, PSFCH,
an Automatic Gain Control, AGC, symbol prior to the PSFCH.

In accordance with embodiments, the UE is to extend the transmission into the guard duration by taking or copying content from a predefined portion of the second part of the COT, e.g., from an end of an Automatic Gain Control, AGC, symbol.

In accordance with embodiments, the further UE performing the transmission over the SL during the first part of the COT is a first further UE, and the UE is to perform the transmission over the SL during the second part of the COT to the first further UE or to a second further UE, the second further UE being different from the first further UE.

### UE Initiating/Sharing COT

In accordance with embodiments, the guard duration has a length of one or more of the following:
a CP length,
an extended CP, ECP, length,
an OFDM symbol length,
a multiple of the length of an OFDM symbol, e.g., ½ or twice the length of an OFDM symbol,
a number of OFDM symbols,
an interframe space, e.g., a short interframe space, SIFS, as used in WiFi systems,
a configured or pre-configured duration defined using, e.g., microseconds.

In accordance with embodiments, the CAP is one of
a Type-1 CAP that senses the channel for a random time duration,
a Type-2A CAP that senses for two sensing slots, e.g., at the beginning and end, within a gap of at least 25 μs,
a Type-2B CAP that senses for one sensing slot of 9 μs within a gap of at least 16 μs,
a Type-2C CAP that does not sense the channel.

In accordance with embodiments, the CAP type used by the UE for its transmission depends on a certain condition.

In accordance with embodiments, the certain condition is one or more of:
a length of the transmission, like a size of data to be transmitted by the UE, wherein the UE is to perform an LBT if the length of the transmission is at or above a predefined threshold, and wherein the UE is not to perform an LBT if the length of the transmission is below the predefined threshold the UE,
a type of data to be transmitted, e.g., the data to be transmitted is feedback data, e.g., PSFCH or the data to be transmitted is an IUC request,
a priority of a control and/or data transmission has a certain priority.

In accordance with embodiments, the COT spans at least a first time slot including a plurality of symbols, the first part of the COT comprising a first number of symbols, the second part of the COT comprising a second number of symbols, and the guard duration comprising a time gap, which is located between the last symbol of the first number of symbols and the first symbol of the second number of symbols.

In accordance with embodiments,
the COT spans at least the first time slot and a second time slot, the second time slot including a plurality of symbols, and the first time slot comprising a further guard duration comprising a time gap, which is the last symbol in the first time slot, and/or
the UE is to extend the transmission into the subsequent guard duration and/or into the further guard duration, or
the further UE is to extend the transmission into the previous guard duration.

In accordance with embodiments, the COT spans at least two time slots, each including a plurality of symbols, the first part of the COT comprising a first time slot, the second part of the COT comprising a second time slot, and the guard duration comprising a time gap, which is the last symbol in the first time slot.

In accordance with embodiments,
the first time slot and/or the second time slot includes a plurality of symbols, the first part of the first time slot and/or the second time slot comprising a first number of symbols, the second part of the first time slot and/or the second time slot comprising a second number of symbols, and the first part of the first time slot and/or the second time slot comprising a further guard duration comprising a time gap, which is located between the last symbol of the first number of symbols and the first symbol of the second number of symbols, and
the UE is to extend the transmission into the subsequent guard duration and/or into the further guard duration, or
the further UE is to extend the transmission into the previous guard duration.

In accordance with embodiments, the predefined time duration is determined in us as follows:

$$( ( \frac{1}{{2}^{μ} \times 14} ) \times 1000 ) - T {G}_{m i n}$$

with
   μ numerology parameter, e.g., μ=0 for 15 kHz Sub Carrier Spacing, SCS, μ=1 for 30 KHz SCS, μ=2 for 60 KHz SCS,
   TGₘᵢₙ minimum time for performing a predefined CAP before accessing the shared COT, e.g., 25 μs for a type-2A LBT or 16 μs for a type-2B LBT.

In accordance with embodiments, the duration of guard symbols decreases with an increase in the subcarrier spacing and/or bandwidth.

In accordance with embodiments, the guard duration has a duration, like a switching time, allowing the UE to switch between a transmission mode and a reception mode.

### System

The present invention provides a wireless communication system, like a 3^{rd} Generation Partnership Project, 3GPP, system, comprising a one or more user devices, UEs, according to embodiments of the present invention.

In accordance with embodiments, the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments, the base station comprises one or more of a macro cell base station, or a small cell base station, or a central unit of a base station, or a distributed unit of a base station, or an Integrated Access and Backhaul, IAB, node, or a road side unit, RSU, or a UE, or a SL UE, or a group leader UE, GL-UE, or a relay or a remote radio head, or an AMF, or an SMF, or a core network entity, or mobile edge computing, MEC, entity, or a network slice as in the NR or 5G core context, or any transmission/reception point, TRP, enabling an item or a device to communicate using the wireless communication network, the item or device being provided with network connectivity to communicate using the wireless communication network.

### Methods

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
occupying the channel within a channel occupancy time, COT,
sharing the COT with a further UE, wherein the COT has a first part and a second part, the first part of the COT and the second part of the COT being separated by a guard duration,
performing a transmission over the SL during the first part of the COT, wherein the second part of the COT is used by the further UE to perform a transmission over the SL, and
extending the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
sharing a channel occupied by a further UE during a channel occupancy time, COT, initiated by the further UE, wherein the COT has a first part and a second part, the first part of the COT and the second part of the COT being separated by a guard duration, and wherein the first part of the COT is used by the further UE to perform a transmission over the SL,
performing a transmission over the SL during the second part of the COT, the first part of the COT and the second part of the COT being separated by a guard duration, and
extending the transmission into the guard duration so as to transmit during a predefined time duration ending at an end of the guard duration, the predefined time duration selected such that an initial duration of the guard duration is sufficient to allow the UE to perform a predefined channel access procedure, CAP, before accessing the shared COT.

The present invention provides a method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
sharing a channel occupied by a further UE during a channel occupancy time, COT, initiated by the further UE, wherein the COT has a first part and a second part, the first part of the COT and the second part of the COT being separated by a guard duration, wherein the first part of the COT is used by the further UE to perform a transmission over the SL, the further UE extending the transmission into the guard duration so as to transmit during a first predefined time duration starting at the beginning of the guard duration,
performing a transmission over the SL during the second part of the COT,
extending the transmission into the guard duration so as to transmit during a second predefined time duration ending at an end of the guard duration.

In accordance with embodiment, accessing the shared COT without performing a Listen-Before-Talk, LBT, procedure before accessing the shared COT.

### Computer Program Product

Embodiments of the first aspect of the present invention provide a computer program product comprising instructions which, when the program is executed by a computer, causes the computer to carry out one or more methods in accordance with the present invention.

Embodiments of the inventive aspect are now described in more detail with reference to the accompanying drawing. It is noted that the subsequently outlined and described aspects or embodiments may be combined such that some or all of the aspects/embodiments are implemented within one embodiment. Further, it is noted that when referring to “resources”, in this description, a resource is to be understood as comprising one or more of the following:
one or more symbols,
one or more time slots or subframes or frames,
one or more frequencies or carriers or subchannels or group of subchannels,
one or more frequency bands, like unlicensed subbands,
one or more bandwidth parts,
one or more resource pools,
one or more LBT sub-bands,
one or more spatial resources, e.g., using spatial multiplexing.

Furthermore, it is noted that when referring to “a set of resources”, in this description, a set of resources may contain one or more than one resource, with the definition of a resource as mentioned above. Moreover, it is noted that when referring to a “channel”, in this description, this may refer to a set of the resources as mentioned above. Thus, a “channel” may also refer to a sub-channel, a sub-band, a resource pool or a SL BWP.

It is noted that in the description given herein, when referring to above mentioned “sharing of the channel occupancy” this is also referred to as a UE sharing the COT or using a shared COT. This means that the UE may use a channel initially occupied by another UE within or during at least a part of the COT that began in response to other UE performing LBT to ensure that the channel is available, initiating the COT and occupying the channel.

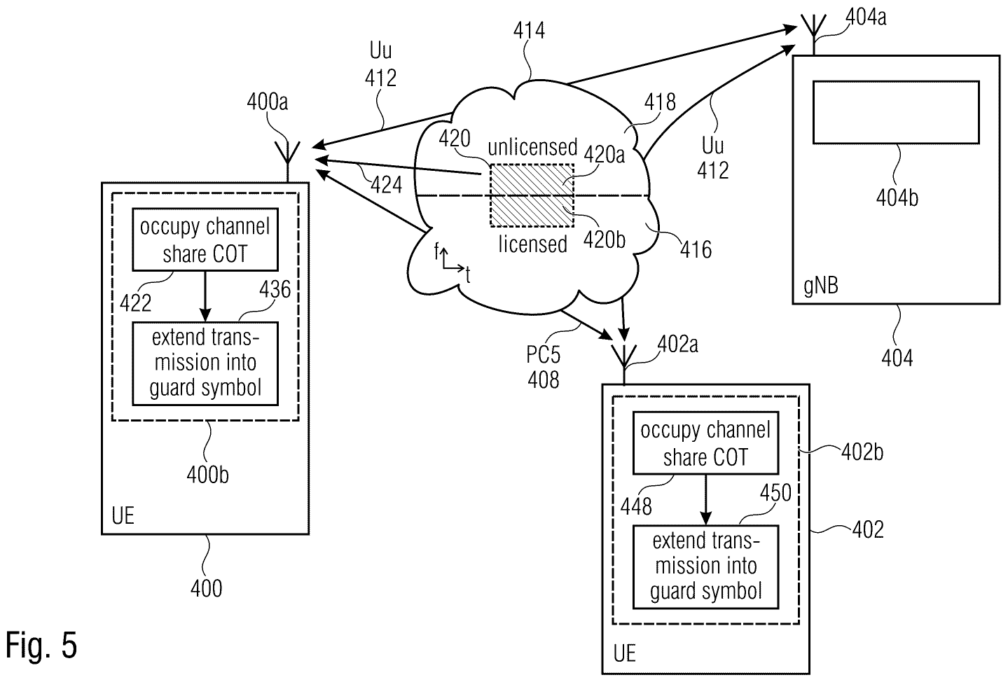

FIG. 5 illustrates a wireless communication system, like the one described above with reference to FIG. 1, FIG. 2 or FIG. 3, for example a 3^{rd} generation partnership project, 3GPP, system or network.

The wireless communication system includes user devices 400, 402 and one or more base station 404 operating in accordance with embodiments of the present invention. UE 400, also referred to as sidelink UE, SL-UE, comprises one or more antennas 400a and a signal processor 400b for performing one or more operations, for example operations involving the antenna 400a, like transmitting/receiving data, like payload data or control data, or inter UE coordination (IUC) messages. UE 400 may communicate with other UEs, like UE 402, using the sidelink or PC5 interface, as is schematically illustrated at 408. UE 402, also referred to as sidelink UE, SL-UE, comprises one or more antennas 402a and a signal processor 402b for performing one or more operations, for example operations involving the antenna 400a, like transmitting/receiving data, like payload data or control data, or inter UE coordination (IUC) messages. Moreover, UE 400 and/or UE 402 may connected to a base station or gNB 404. The gNB 404 includes one or more antennas 404a for the wireless communication with the other network entities, like UEs 400 and/or 402, and a signal processor 404b. When operating in Mode 1, UE 400 and UE 402 receives via the Uu interface 412 resources allocated by the gNB 404 that are to be used by the UE for the communication over the sidelink 408. As mentioned above, when operating in Mode 2, UE 400 and/or UE 402 may not have a connectivity to the gNB 404 and a sensing based resource allocation or a random access-based resource allocation is performed priori to performing a transmission.

FIG. 5 further illustrates, schematically, the spectrum 414, like the radio spectrum including the resources to be used for a communication within the wireless communication system or network. The resources available for the SL communication may comprise one or more of the following: one or more symbols, one or more time slots or subframes or frames, one or more resource blocks (RBs) or frequencies or carriers or subchannels or group of subchannels, one or more frequency bands. As is further illustrated, schematically, the spectrum 414 comprises the licensed spectrum 416 and the unlicensed spectrum 418. The licensed spectrum 416 is the part of the spectrum that is reserved for the wireless communication system including the UEs 400 and 402 as well as the base station 404. In other words, resources in the licensed spectrum are for exclusive use by this wireless system, as defined by regulatory bodies and entities. The unlicensed spectrum 418 includes resources that may be used by a plurality of wireless communication systems, for example by another wireless communication system in accordance with the 3GPP standard but operated by a different operator, or by systems using a different radio access technology, like WiFi or Bluetooth.

In accordance with embodiments, for the sidelink communication a resource pool 420, also referred to as sidelink resource pool, SL-RP, may be provided, and UE 400 is configured or preconfigured with the resource pool 420. Although the figure depicts only a single resource pool, multiple such resource pools may be configured or preconfigured. The resource pool may include resources from the unlicensed spectrum 418 only or from the licensed spectrum 416 only, or, as is depicted in the embodiment of FIG. 5, may comprise resources from the licensed spectrum 416 and from the unlicensed spectrum 420. In accordance with further embodiments, the resources in the unlicensed spectrum may be aggregated using carrier aggregation.

In accordance with embodiments of the present invention, UE 400, is a SL-UE communicating over the SL using resources from the unlicensed spectrum, and for the following description of embodiments of the present invention UE 400 is assumed to be the above-mentioned COT initiating UE or initiating UE, while UE 402 is assumed to be the COT sharing UE or responding UE. The inventive approach is not limited to such a scenario, rather, UE 400 may share the COT with one or more other network entities of the wireless communication network. For performing a transmission over the sidelink 408, for example towards one or more further UEs, like UE 402, UE 400, as is illustrated at 422, occupies the channel, i.e., resources spanning a certain time in the time domain and a certain frequency in the frequency domain. Occupying the channel further begins or starts a channel occupancy time, COT. In accordance with embodiments, UE 400 occupies the channel responsive to a successful channel access procedure, CAP, which UE 400 performed on the channel. In accordance with other embodiments, UE 400 may receive assistance, e.g., from gNB 404 or from any other network entity, so that it may not be required to perform a CAP on the channel. UE 400 may receive information about the resources or channel to use for a transmission, for example, gNB 404 may provide a grant which indicates the channel, like the resources in the unlicensed spectrum, to be used by UE 400 for performing a transmission on the sidelink. UE 400 may also perform sensing and resource selection when operating in Mode 2 to determine the resources to be used for a transmission. In either case, the UE 400 performs CAP and as is illustrated at 422, UE 400 occupies the channel for the transmission and the COT is started. Following a successful CAP causing a channel to be occupied by UE 400 and beginning the COT, UE 400 may share the COT with another network entity, like UE 402, also referred to as a responding or further UE, as is illustrated at 422 in FIG. 5.

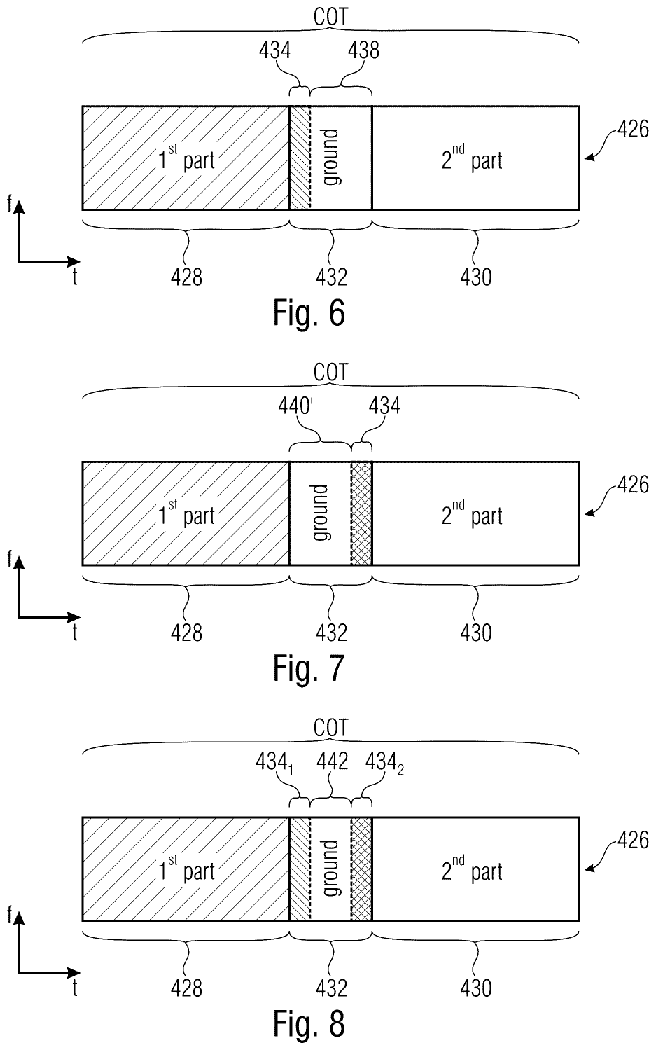

The channel occupied by UE 400 within the COT is schematically illustrated in FIG. 6 and extends in the time domain for the COT and in the frequency domain over a certain number of frequencies or subcarriers. FIG. 6 illustrates the shared channel 426 having a duration corresponding to the COT. The COT has a first part 428 and a second part 430 separated by the guard duration 432. The first and second parts of the COT may have a structure as described above with reference to FIG. 3, and the guard duration 432 may comprise one or more guard symbols. As mentioned above, during the guard duration 432, neither one of UE 400 and UE 402 transmits. Thus, to a further device, like a non-3GPP device, when performing a CAP during the guard duration 432, the channel or band 426 appears to be idle and it may occupy the channel 426 thereby disrupting the COT sharing. To address this problem, in accordance with embodiments of the present invention, UE 400 which occupied the channel 426, thereby beginning the COT, performs its transmission during the first part 428 of the COT and, as is indicated at 434 extends the transmission into the guard duration 432 thereby effectively shortening the duration during which the channel 426 appears idle to other devices. This reduces or even eliminates the possibility that another device may take over the channel 426 and occupy the channel for its own transmissions. In other words, in accordance with the inventive approach, the guard duration 432, like a guard symbol as described above with reference to FIG. 3, may be used as the required time gap for a responding UE to perform the necessary channel access procedure while using a shared COT, however, by extending the transmission in the first part 428 by UE 400 into the guard duration 432 for a configured or preconfigured time duration, it is avoided that the actual time gap for performing the CAP during the guard duration or guard symbol 342 becomes too long (dependent on the SCS and numerology used) so that a CAP by another device yields also the guard duration to be busy so that an occupation of the channel 426 by the other device is avoided or at least the likelihood is substantially reduced.

Thus, in accordance with the embodiment of FIG. 5, the channel 426 occupied by UE 400 within the COT is used, during a first part of the COT, for a transmission by UE 400 over the sidelink, while the second part 430 may be used by UE 402 to perform also a transmission over the sidelink. As is indicated at 436 and as explained above with reference to FIG. 6, UE 400 extends its transmission into the guard duration 432 so as to transmit during a predefined time duration thereof which, as may be seen from FIG. 6, starts at the beginning of the guard duration with the time duration being selected such that the remaining duration 438 of the guard duration 432 is sufficient to allow UE 402 to perform a predefined channel access procedure before actually accessing the shared COT or channel 426.

It is noted that UE 400 may perform a transmission of the sidelink during the first part 428 of the COT which is directed to UE 402 or to any other UE being in the vicinity of UE 400 and capable to communicate this UE 400 over the sidelink. Likewise, UE 402 may use the second part 430 of the COT to perform a transmission towards the initiating UE 400 or to any other UE in the surroundings and capable of communicating with UE 402 over the sidelink.

In accordance with embodiments, for extending the transmission into the guard duration 432, UE 400 may take or copy certain content from a predefined portion of the first part 428 of the COT or the first part of the transmission in the previous symbol prior to the guard symbol. In other words, some information transmitted during the first part 428 of the COT may be simply copied into the guard duration 432. When considering the sidelink frame structure as described above with reference to FIG. 3, in accordance with embodiments, UE 400 may take information from a beginning of a last transmission symbol, like a PSSCH symbol that precedes the guard symbol and follows a cyclic prefix of the data in the last PSSCH symbol. In accordance with other embodiments, the last transmission symbol may include an AGC symbol, a DMRS, a data channel, e.g., a PSSCH, a control channel, e.g., a PSCCH, or a feedback channel, e.g., a PSFCH. Also, any other kind of information, even information not associated with the transmission to be performed by the initiating UE, may be employed which is not critical because this information transmitted during the duration 434 is not considered or actually decoded.

In accordance with other embodiments, the inventive approach may be implemented not by the initiating UE 400 but by the responding UE 402 which, like the initiating UE 400 performs the sidelink communication using a channel comprising resources from the unlicensed spectrum 418. UE 402, acting as the responding UE, receives from the initiating UE 400 an indication that UE 400 occupied a channel and shares the COT with UE 402, like channel 426 described above with reference to FIG. 6. FIG. 7 illustrates how the responding UE 402 operates in accordance with embodiments of the present invention for overcoming the problems with conventional approaches using a completely free guard duration 432. As mentioned above, the responding UE 402 shares the channel 426 within the COT with the initiating UE 400 which, during the first part 428 of the channel 426, performs a transmission on the sidelink, and provides UE 402 with the COT information during the first part 428, such that the responding UE 402 may perform a transmission on the sidelink during the second part 430 of the COT. Other than in the above described embodiment regarding the initiating UE, in the present embodiment, the responding UE 402 extends its transmission into the guard duration 432 so as to transmit during a predefined time duration 434 which starts at a time from the start of the guard duration 432 and ends or terminates at the end of the guard duration 432 so that the initial duration 440 at the beginning of the guard duration 432 is sufficient to allow the responding UE 402 to perform a predefined channel access procedure before accessing the channel 426. In other words, UE 402 begins its transmission at the beginning of 434, and continues on into the second part 430. The responding UE 402 may extend its transmission into the guard duration 432 by taking or copying content from a predefined portion of the second part 430 of the COT or the last part of the transmission in the next symbol. For example, content from an end of an automatic gain control, AGC symbol may be taken and copied into the duration 434. When considering the sidelink frame structure as described above with reference to FIG. 3, in accordance with embodiments, UE 400 may take information from the end of the next transmission symbol, like an AGC symbol that is after the guard symbol. In accordance with other embodiments, the next transmission symbol may include an AGC symbol, a DMRS, a data channel, e.g., a PSSCH, a control channel, e.g., a PSCCH, a feedback channel, e.g., a PSFCH, or an AGC symbol prior to the PSFCH. Also, any other kind of information, even information not associated with the transmission to be performed by the responding UE, may be employed which is not critical because this information transmitted during the duration 434 is not considered or actually received.

In accordance with yet further embodiments, the embodiments described with reference to FIG. 6 and FIG. 7 may be combined so that both the initiating UE 400 and the responding UE 402 extend their respective transmissions into the guard duration 432. FIG. 8 illustrates a channel 426 shared within the COT by UE 400 with UE 402. The initiating UE 400 performs a transmission over the sidelink during the first part 428 of the COT, and the responding UE performs a transmission over the sidelink during the second part 430 of the COT. Both the initiating UE 400 and the responding UE 402 extend their transmissions into the guard duration 432 by a first time duration 434₁ and by a second time duration 434₂, respectively, leaving an intermediate duration of 442 of the guard duration 432 void. It is noted that in accordance with other embodiments, the transmissions by the two UEs may be extended in such a way that there is no void area 442, i.e., the extended transmission by the responding UE 402 may start at the time the extended transmission of the initiating UE ends. In other words, in accordance with the embodiment of FIG. 8, the void duration of the guard duration or guard period 432 may be completely eliminated or reduced to a short time interval 442 in the middle of the guard duration 432. In such a scenario, the responding UE is allowed to access the shared channel or shared COT 426 without performing a channel access procedure before accessing the shared COT 426, also referred to as a LBT-less access. In the embodiment of FIG. 8, the extension of the transmissions into the guard duration 432 may be performed in a way as described above with reference to FIG. 6 and FIG. 7.

It is noted that, in accordance with other embodiments, the approach according to FIG. 8 may also be achieved by extending a transmission of the initiating UE 400 according to FIG. 6 so as to occupy the whole or substantially the whole guard period. In such a scenario the above mentioned intermediate duration of 442, if any, is at the end of the guard period. In accordance with yet other embodiments, the approach according to FIG. 8 may also be achieved by extending a transmission of the responding UE 402 according to FIG. 7 so as to occupy the whole or substantially the whole guard period. In such a scenario the above mentioned intermediate duration of 442, if any, is at the beginning of the guard period.

With regard to the above described embodiments depicted in FIG. 6 to FIG. 8, the respective transmissions may be such that the initiating UE 400 transmits towards the responding UE or to any other UE, and that the responding UE 402 transmits towards the initiating UE 400 or to any other UE.

In scenarios in which the transmission in the first part performed by the initiating UE is directed to the responding UE 402, the responding UE 402 is aware of the transmission directed to it, for example from the SCI message received which also included the COT sharing information, and during the first part of the COT the responding UE is in a receiving mode. At the end of the first part 428 and during the gap duration 432 the responding UE may switch into the transmission mode so as to allow transmitting over the sidelink during the second part. In the embodiment of FIG. 6, the information transmitted by the initiating UE 400 during the guard duration 432 is not needed by the responding UE so that at the interface between the first part 428 and the guard duration 432 the responding UE may start switching from the receiving mode to the transmitting mode as there is no need for receiving the extended transmission during the guard duration 432 as this may be a copy of the already transmitted information, as stated above, or any other kind of signal which, however, is not part of the actual transmission to be received by the responding UE 402.

Likewise, in the embodiment of FIG. 7, in case the transmission performed by the responding UE is directed to the initiating UE 400, the initiating UE 400 may start switching from the transmitting mode into the receiving mode during the guard duration 432 as the transmission by the responding UE which has been extended into the guard duration so as to retain the COT during the time duration 434 at the end of the guard duration need not to be received by the initiating UE 400 as this is either redundant information also included in the actual transmission transmitted during the second part 430 or is any arbitrary information not intended to be a part of the transmission towards the initiating UE.

With regard to the embodiment of FIG. 8, in a situation in which the transmission by the initiating UE 400 during the first part 428 is directed to the responding UE 402, and the transmission performed by the responding UE during the second part 430 is also directed to the initiating UE 400, the intermediate duration 442 of the guard duration and the time durations 431₁ and 434₂, respectively, are selected such that the combined durations 434₂ and 442 are sufficient for allowing the initiating UE to switch from the transmitting mode to the receiving mode, and such that the combined durations 434₁ and 442 are sufficient for allowing the responding UE to switch from the receiving mode to the transmitting mode.

Thus, in the scenario of FIG. 8, the responding UE 402 may switch during the first part of the guard duration 432 (combined durations 434₁ and 442) while the initiating UE 400 continues to transmit. After switching, the responding UE 402 may start transmitting, for example, by extending an AGC symbol, while the initiating UE 400 has sufficient time (time durations 434₂ plus 442) to switch from transmitting mode to receiving mode so as to allow UE 400 to receive the AGC and the transmission performed by the responding UE during the second part 430 of the COT.

Embodiments of the present invention have been described above with reference to FIG. 5 to FIG. 8, and the channel 426 has been assumed to have a certain duration within the COT. In accordance with embodiments, the channel 426 may include one or more time slots, like one or more time slots as illustrated above with reference to FIG. 3. In accordance with embodiments, the channel 426 may include one or more time slots having a frame structure according to FIG. 3A or one or more time slots having a frame structure according to FIG. 3B. Also the channel may include two or more time slots with one of the time slots having a frame structure as in FIG. 3A and another one having a frame structure as described above with reference to FIG. 3B.

Thus, in accordance with embodiments, when employing time slots having frame structures as described above with reference to FIG. 3, more than one guard duration 432 exist so that a further guard duration may be present between the second part 430 of the COT and a third part or further part of the frequency band. In case the further part of the frequency band is not part of the shared channel 426, there is no need for applying the inventive approach to the further guard duration which, for example, follows the second part 430 of the COT, is at that time the COT sharing is terminated so that another device may actually occupy the frequency band or channel for its own transmission. However, in case the COT has a duration extending over the first and second parts and also over a further part, the respective parts may be separated by guard durations, and the inventive approach may be applied for minimizing the probability that the channel is occupied by another device, like a non-3GPP device.

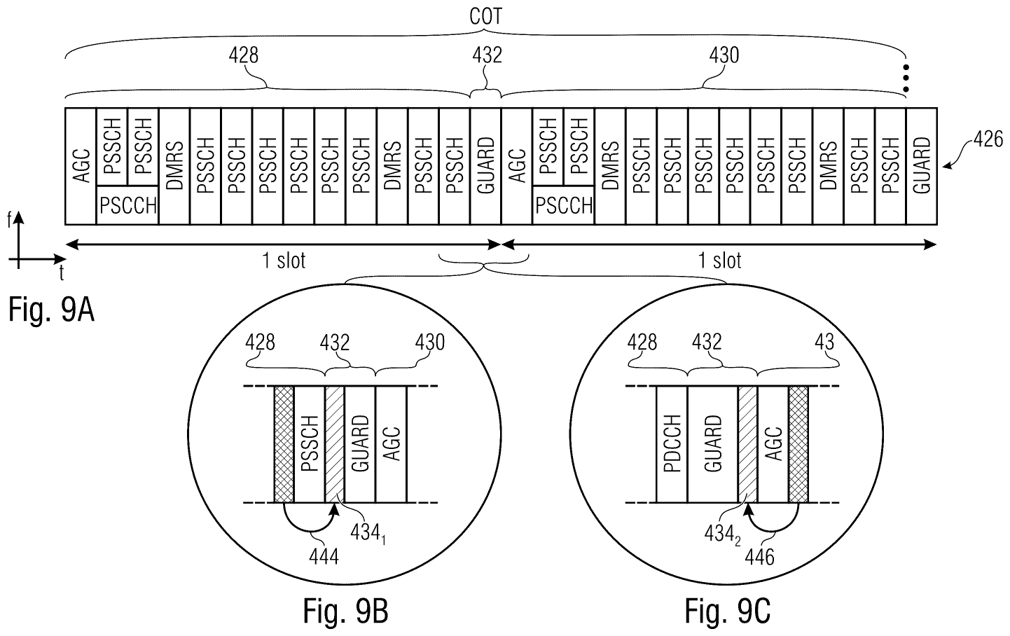

In the following, further embodiments of the inventive approach are described with reference to channels employing a frame structure in accordance with FIG. 3A. FIG. 9A illustrates an embodiment in accordance with which the channel 426 occupied initially by the COT initiating UE 400 in FIG. 5 comprises two time slots having a structure as in FIG. 3A, and the COT is assumed to start with the first symbol in the first time slot 428 forming the first part of the COT, end to end with the PSCCH symbol in the second time slot 430 forming the second part of the COT. For avoiding that the channel 426 is taken over and occupied by another device the inventive approach is applied with regard to the guard symbol 432 which is the last symbol of the first time slot 428. As described above with reference to FIG. 6 and FIG. 7, either a part of the transmission by the initiating UE 400 in the first time slot 428 may be extended into the guard symbol 432 or a part of the transmission performed by the responding UE in the second time slot 430 may be extended into the guard symbol 432. FIG. 9B illustrates the situation in which the transmission of the initiating UE 400 is extended in to the guard period or guard symbol 432 by copying the first part of the PSSCH into the first part of the guard symbol 432, as is schematically represented by arrow 444 so that the transmission is extended by the time duration 434₁. FIG. 9C illustrates an embodiment in accordance with which the transmission of the responding UE is extended into the guard symbol 432, as is described above with reference to FIG. 7. In accordance with the depicted embodiment, a part of the AGC symbol, for example an end portion thereof may be copied, as is indicated by arrow 446 at the end of the guard symbol thereby defining the time duration 434₂ by which the transmission of the responding UE is extended into the guard symbol 432. Also, the approaches of FIG. 9B and FIG. 9C may be combined in a way as described above with reference to FIG. 8 so that the transmissions of both the initiating UE 400 and the responding UE 402 are extended into the guard symbol 432.

As is indicated in FIG. 9, the COT ends at the last PSSCH symbol of the second time slot 430 and no action with regard to the further guard symbol at the end of the second time slot is required, as at this time, the COT ends so that the band or channel 426 is free to be occupied by other devices.

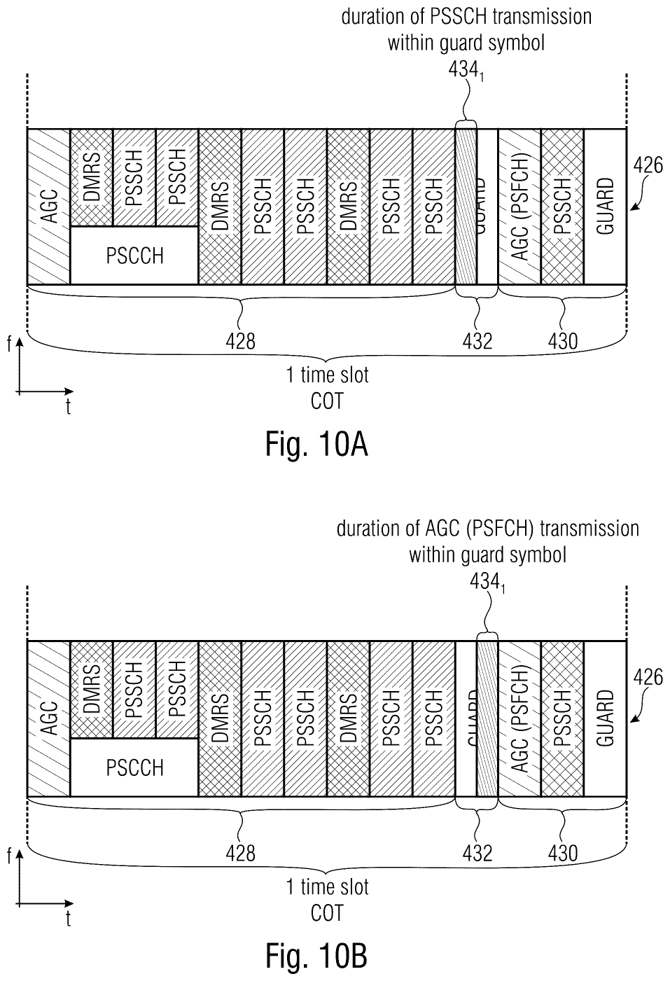

Further embodiments of the present invention shortening a void time of a guard symbol are now described with reference to the sidelink frame structure according to FIG. 3B. As mentioned above, in accordance with the inventive approach, the guard symbol is employed so as to provide for the required time gap for the responding UE to perform the necessary CAP, like a LBT, when using the shared COT. FIG. 10 illustrates an embodiment assuming a COT to have a duration of one time slot, and during the first part 428 of the COT, which extends over 10 symbols, the COT initiating UE 400 performs a transmission. During the second part 430 of the COT covering the 12th and 13th symbol of the COT, the responding 402 performs a transmission. The 11th and 14th symbols are guard symbols in which, conventionally, nothing is transmitted by the initiating UE 400 and the responding UE 402. In accordance with FIG. 10A the guard symbol 432 between the PSSCH and the PSFCH is considered, and the initiating UE transmitting the PSSCH extends this transmission of the PSSCH into the guard symbol 432, as is illustrated in FIG. 10A at 434₁ so that a configured or preconfigured time duration within the guard symbol 432 starting at the beginning of the guard symbol 432 experiences the PSSCH transmission. Thus, the duration during which the guard symbol 432 is idle is reduced, so that other devices performing a CAP are likely to consider the guard symbol to be busy, due to the additional transmission during the duration 434₁, so that the likelihood of the channel 426 being taken over and occupied by another device performing a CAP in the guard symbol 432 is substantially reduced or even eliminated.

FIG. 10B illustrates a similar case as in FIG. 10A except that the transmission from the responding UE is extended into the guard symbol 432, as described above with reference to FIG. 7 in more detail. In the embodiment of FIG. 10B the responding UE starts the transmission before the end of the guard symbol thereby covering the time duration 434₂ at the end of the guard symbol 432. In accordance with FIG. 10B the responding UE extends the transmission of the AGC for the PSFCH into the preceding guard symbol for the configured or preconfigured time duration 434₂.

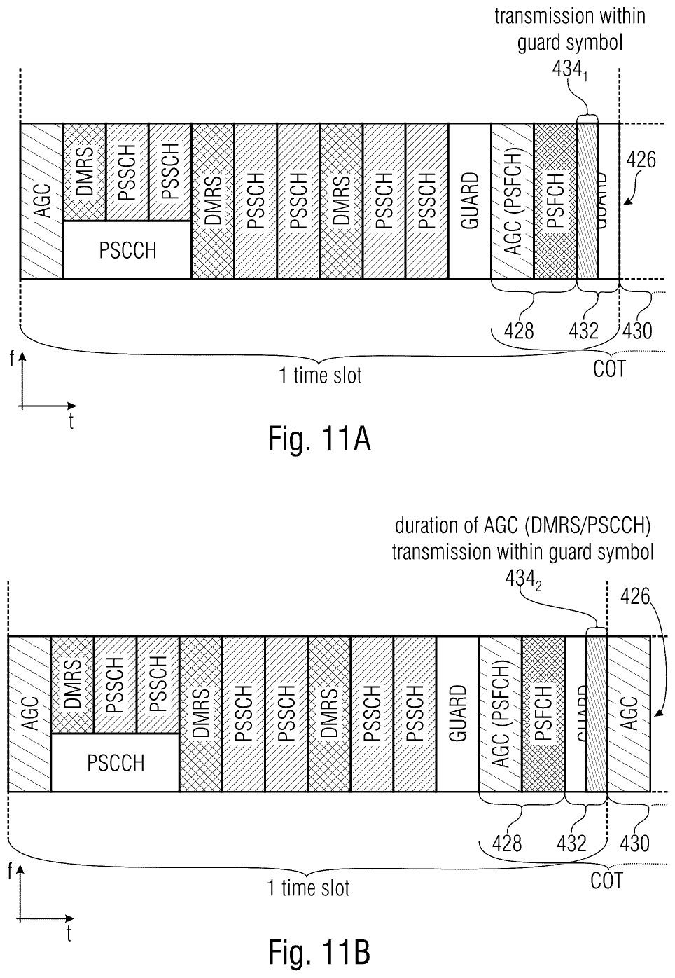

FIG. 11 illustrates yet a further embodiment of the inventive approach in accordance with which it is assumed that the COT covers a first time slot and at least one following time slot. The first time slot is assumed to have a frame structure as illustrated in FIG. 3B, while the second or any further time slot may have a structure as in FIG. 3A or as in FIG. 3B or any other frame structure. As is illustrated in FIG. 11A, it is assumed that the COT starts at the 11th symbol of the time slot and in accordance with such embodiments, the COT initiating UE may be UE 402 which, for example for sending the PSFCH, occupies the channel 426 within the COT so that, in the depicted embodiment, the first part 428 of the COT comprises the 12th and 13th symbol of the first time slot and the second part 430 of the COT includes symbols from a following time slot, the two slots being separated by the guard symbol 432. UE 402 may also start the COT from the 1st symbol of the time slot for transmitting control and data and occupies the channel 426 within the COT so that the first part 428 of the COT comprises the 1st to 10th symbol of the first time slot and for sending the PSFCH related to a previous transmission, occupies the 12th and 13th symbol of the first time slot, and avoids another device from using the COT by extending the PSSCH transmission in the 10th symbol into the guard symbol in the 11th symbol. For avoiding the channel 426 to be occupied by another device performing a CAP during the guard symbol 432, in accordance with embodiments of the inventive approach, UE 402 occupies the channel for the PSFCH transmission and shares the COT (see 448 in FIG. 5) and extends its transmission of the PSFCH into the guard symbol 432 (see 450) in FIG. 5) as described above with reference to FIG. 7 except that the transmission in the first part 428 is now by UE 402. Thus, UE 402 extends the transmission of the PSFCH into the guard symbol 432 for the duration 434₁.

FIG. 11B illustrates a further embodiment in accordance with which the transmission of the next time slot or second part 430 of the COT is extended into the guard symbol 432. For example, the UE transmitting during the second part 430 of the COT, i.e., the COT sharing UE which, in this embodiment, may be UE 400, extends the transmission of the AGC symbol into the guard symbol 432 at the end of the preceding time slot for the time duration 434₂.

As also mentioned above with reference to FIG. 7, in the embodiment of FIG. 10B and in the embodiment of FIG. 11B the UE receiving the transmission in the second part 430 of the COT performs the AGC measurement of the AGC symbol alone following the guard symbol 432 into which the transmission of the transmitting UE has been extended, according to the symbol boundaries. In other words, any excess spillage from the guard symbol does not affect the AGC measurement before the PSFCH, PSSCH or PSCCH transmission since the measurement is performed in the AGC symbol alone, and the UE does not consider the transmission of the AGC in the guard symbol for AGC measurement.

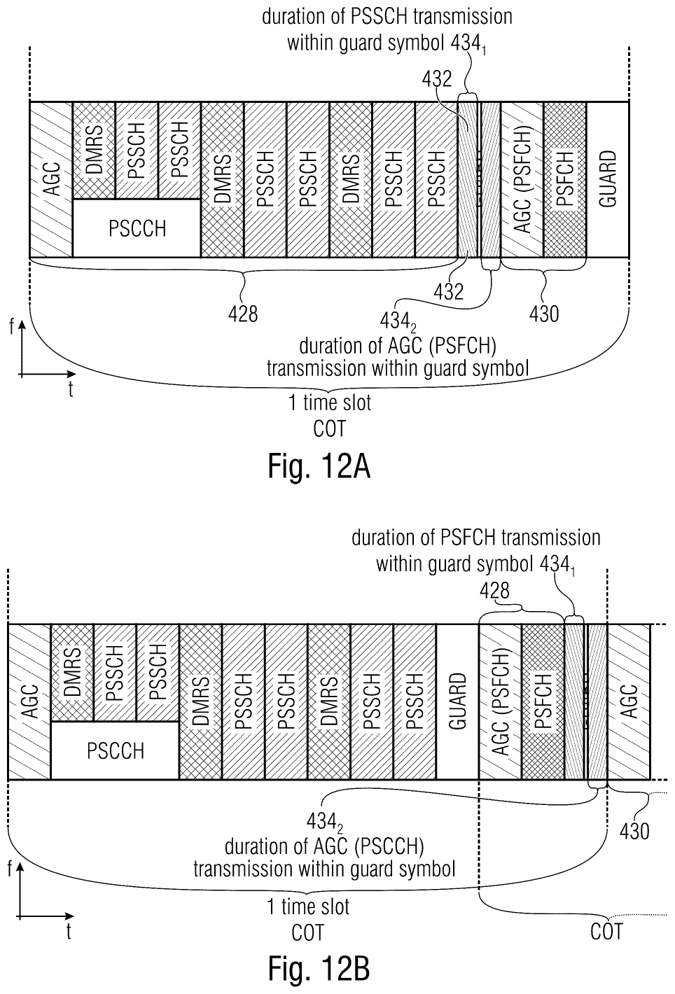

FIG. 12 illustrates embodiments in accordance with which transmissions from both the initiating UE and the responding UE are extended into the guard symbol 432, and FIG. 12A illustrates a combination of the embodiments of FIG. 10A and FIG. 10B, while FIG. 12B illustrates a combination of the embodiments of the FIG. 11A and FIG. 11B. Thus, as has been described in more detail with reference to FIG. 8 above, both at the beginning of the guard symbol as well as at the end of the guard symbol 432 transmissions from the initiating UE and from the responding UE extend for a certain time duration 431₁ and 434₂, respectively, into the guard symbol 432 with the intermediate void region 442 being either substantially reduced or completely eliminated. In other words, combining the above-mentioned embodiments in the ways described with reference to FIG. 12 allows eliminating or reducing the time duration during which the guard symbol or guard period appears idle as in such a case there is only a short interval 442 or no time period at all during which the guard symbol 432 is idle.

As described above with reference to FIG. 8, this may enable a gap-less LBT for a transmission, like a feedback transmission, by having the responding UE switch in the first part of the guard symbol while the initiating UE continues to transmit. Following the switching the responding UE may start transmitting, for example by extending the AGC symbol into the guard symbol 432 while the initiating UE has sufficient time to switch from the transmitting mode into the receiving mode so as to receive the actual AGC symbol in the two symbols following the guard symbol 432. The same applies for the guard symbol 432 being located at the end of the time slot as indicated in FIG. 12B.

In accordance with further embodiments, the switching time between the receiving mode and the transmitting mode is maintained when enabling gap-less LBT when the initiating UE 400 transmits a part of the previous symbol 434₁ into the guard symbol 432, while the responding UE 402 performs the switch from receiving to transmitting mode from the beginning of the guard symbol, following which the initiating UE 400 performs the switch from the transmitting to receiving mode from the end of its transmission 434₁ into the guard symbol 432, until the end of the guard band, while the responding UE 402, having already completed the switch, begins the transmission of a part of the following symbol 434₂ within the guard band 432.

The actual duration of the extended transmission in the guard symbol may depend on the numerology, e.g., on the subcarrier spacing, SCS. For example, as indicated in the above table, a SCS of 15 kHz leads to a symbol length or duration of 71.36 μs which is long enough for a responding UE to perform, for example, a Type-2A LBT. However, this duration is also long enough for another device to take over the channel. When considering a SCS of 60 kHz, the symbol length is 17.84 μs so that still a Type-2B or Type-2C CAP is possible. Thus, in order to maintain a minimum time gap TGₘᵢₙ for the UE to perform a Type 2 CAP, and to ensure at the same time that other devices do not occupy or take over the band or channel, in accordance with embodiments, the following relation is used to determine the time duration within the guard symbol that either the initiating UE transmits, for example, the PSSCH, or the responding UE transmits, for example, the PSFCH AGC. The predefined time duration 434₁ and 434₂, respectively, may be defined in us as follows:

$$( ( \frac{1}{{2}^{μ} \times 14} ) \times 1000 ) - T {G}_{m i n}$$

with
   μ numerology parameter, e.g., μ=0 for 15 kHz Sub Carrier Spacing, SCS, μ=1 for 30 KHz SCS, μ=2 for 60 KHz SCS,
   TGₘᵢₙ minimum time for performing a predefined CAP before accessing the shared COT, e.g., 25 μs for a type-2A LBT or 16 μs for a type-2B LBT.

It is noted that in case the above equation results in a negative value, the UE does not have anything to transmit in the guard symbol. This is because if the equation results in a negative value, it means that the minimum time gap required for performing the CAP is more than the symbol length duration of a guard symbol. Hence the UE does not have to transmit anything in the guard symbol since it requires the guard symbol in its entirety to perform the CAP, and possibly more guard symbols may be needed to be introduced for the UE to perform the CAP.

It is noted that in accordance with embodiments, the choice of the type of CAP or LBT to be performed by the responding UE depends on the transmission that the responding UE intends to transmit. In the case where the responding UE is transmitting a PSFCH or another short transmission, the responding UE may perform a Type-2B or a Type-2C CAP whereas it may perform a Type 1 or Type-2A CAP in case of transmitting a longer transmission, like a PSCCH and/or a PSSCH.

In accordance with further embodiments, when considering a high subcarrier spacing, which leads to a reduction in the length of the OFDM symbols, the required gap for performing the CAP may no longer fit into the existing slot structure. In accordance with embodiments, in such a situation, one or more guard symbols may be introduced at the end of the slot or at the beginning of the slot, or, in the examples of FIG. 3B between the PSSCH and the PSFCH. For example, when considering a 60 KHz SCS, the symbol length is only 17.84 μs, however, the minimum gap for a Type 2A CAP is 25 μs so that in such a case, two guard symbols are need. In accordance with another example, when considering a 30 KHz SCS, the single symbol length is 35.68 μs, while the switching time between transmitting mode and receiving mode, also referred to as the AGC settling time, is 35 μs. Also in such a case a further guard symbol may be in introduced, thereby extending the guard period which allows for a gapless LBT, as described above with reference to FIG. 8. In such a case, the initiating UE continues transmitting in the first guard symbol having the length of 35.68 μs, while, at the same time, the responding UE has sufficient time, namely at least 35 μs, for switching from the receiving mode to the transmitting mode, while the second guard symbol allows the initiating UE to switch from the transmitting mode to the receiving mode while the responding UE already transmits.

In accordance with further embodiments, certain restrictions may apply. For example, the purpose of the guard symbol is, inter alia, to ensure that the initiating UE has sufficient time to switch from the transmitting mode to the receiving mode or from the receiving mode to the transmitting mode. In case the guard symbol is shortened by using a higher SCS and the introduction of a further guard symbol is not possible by design or configuration, and the initiating UE transmits the PSSCH, the responding UE may not use the PSFCH in the same time slot to transmit the feedback back to the initiating UE but to a different UE since the initiating UE does not have enough time to switch to the receiving mode. For example, when considering a 30 KHz SCS, the single symbol length is 35.68 μs, while the switching time between transmitting mode and receiving mode, also referred to as the AGC settling time, is 35 μs. In the absence of a further guard symbol, the initiating UE does not have enough time to switch from transmitting mode to receiving mode and perform an extended transmission within the guard symbol in order to receive any PSFCH transmissions from the responding UE in the same time slot. In this case, the responding UE may use the COT and the PSFCH within the same time slot, but only to transmit to another UE. Thus, in case where the initiating UE transmitted data in the PSSCH, all other UEs in the vicinity of the initiating UE, expect for the responding UE, may transmit an extended cyclic prefix (CPE) followed by the PSFCH using a gapless LBT or CAP. This is because the responding UE requires the time provided by the guard symbol for switching from the receiving mode to the transmitting mode. In other words, if the guard between PSSCH and PSFCH is shortened and if the transmitter UE, UE₁, of the PSSCH is also the recipient of the feedback, then it may be that for UE₁ the switching time is not large enough to receive the beginning of the feedback symbol from the recipient UE, UE₂. Another UE, UE₃, may switch earlier and receive the feedback. Nevertheless, if UE₁ is aware of the smaller gap, it may just receive the later part of the symbol, which may still be fine for decoding the feedback message.

Further, due to the additional half-duplex issue that is caused by this scenario, the resources affected may be included in a set of non-preferred resources of an assistance information message (AIM) which is reported by the UE. As described above, in the case where UE₁ may not receive PSFCH in the same time slot due to the inadequate switching time, the time slot or PSFCH resource may be included in a set of non-preferred resources of an inter-UE coordination (IUC) or AIM, such that when UE₁ provides an AIM or IUC to UE₂, it includes the time slot in the list since it is not able to receive any PSFCH transmission in the said time slot due to the half-duplex issue.

In case where the UE intends to transmit the PSFCH in a time slot with no other UE using the preceding PSCCH or PSSCH in the same time slot, the responding UE may perform a Type-1 CAP to check for the availability of the band or channel and transmit the AGC and the PSFCH as usual. There is also the possibility of multiple starting symbols within a time slot for a UE to start its PSCCH/PSSCH transmission, where the UE uses a mini slot for its transmissions, as described in European Patent Application 22170639.3, “SL UNLICENSED FRAME STRUCUTRE”, filed on Apr. 28, 2022 and incorporated herein by reference. Assuming that the starting symbol for the transmission is from the 8th symbol, and there are no UEs transmitting PSCCH or PSSCH within the mini time slot, the UE may perform the LBT at a secondary starting point within the time slot, and then transmit an extended CPE of dynamic lengths until the start of the AGC-PSFCH symbols.

As described above, embodiments of the present invention provide:
A user device, UE, for a wireless communication network, like a 3^{rd} Generation Partnership Project, 3GPP, network.
   In terms of the 5G NR standard the user device, UE, in the embodiments may correspond to a user equipment (UE) in the standard.
The UE is to perform a sidelink, SL, communication using a channel comprising resources from an unlicensed spectrum.
   In the 5G NR standard the NR sidelink on unlicensed spectrum (SL-U) is specified for NR Rel-18.
The UE is to occupy the channel within a channel occupancy time, COT, and share the COT with a further UE.
   According to RAN₁ #109-e (9-20 May 2022), UE-to-UE COT sharing is supported in NR sidelink operation in a shared channel (SL-U).
The COT has a first part and a second part, the first part of the COT and the second part of the COT being separated by a guard duration.
   According to RAN₁ #113 (22-26 May 2023), for the case where a COT initiating UE uses Type 1 channel access procedure to initiate a SL transmission, it is supported that the COT initiating UE can transmit transmission(s) within the same channel occupancy that follows a COT responding UE's SL transmission(s) according to the channel access procedures. According to RAN₁ #113 (22-26 May 2023), for the time-domain information to be included as part of COT sharing information, at least the following is included: Remaining COT duration.
Thus, the UE sharing the COT can perform transmissions within the COT, and the second part of the COT is shared with another UE. The COT sharing information includes the duration of the second part of the COT which corresponds to the remaining COT time. Thus, the COT is divided into a first and a second part as is also stated in the embodiments.
   Further, according to RAN₁ #113 (22-26 May 2023), if a responding UE shares a channel occupancy initiated by a COT initiating UE using Type 1 SL channel access procedure on a channel, the responding UE may transmit a SL transmission that follows a SL transmission by the COT initiating UE after a gap as follows:
      If the gap is at least 25 μs, the responding UE can transmit the SL transmission on the shared channel after performing Type 2A SL channel access procedures.
      If the gap is equal to 16 μs, the responding UE can transmit the SL transmission on the shared channel after performing Type 2B SL channel access procedures.
      If the gap is up to 16 μs and the transmission is limited to 584 μs, the responding UE can transmit the SL transmission on the channel after performing Type 2C SL channel access.
Thus, the guard period in the embodiments may correspond to the SL transmission after a gap.
The UE is to perform a transmission over the SL during the first part of the COT.
   According to RAN₁ #113 (22-26 May 2023), for the case where a COT initiating UE uses Type 1 channel access procedure to initiate a SL transmission, it is supported that the COT initiating UE can transmit transmission(s) within the same channel occupancy that follows a COT responding UE's SL transmission(s) according to the channel access procedures.
Thus, the UE in the embodiments may correspond to the COT initiating UE in the mentioned agreement.
The second part of the COT is used by the further UE to perform a transmission over the SL,
   According to RAN₁ #113 (22-26 May 2023), when a UE performs Type 2 channel access to start transmitting within a shared COT (to be further studied and down-selected in RAN₁ #114)
      Alt. 1: Use the method for using CPE for the case when UE performs Type 1 channel access to initiate a COT for PSCCH/PSSCH transmission.
      Alt. 2: Use only the (pre-) configured default CPE starting position.
      Alt. 3: Use CPE to make the gap smaller or equal 16 μs.
      Alt. 4: Others
   According to RAN₁ #114(21-25 Aug. 2023), when a UE performs Type 2 channel access to transmit PSCCH/PSSCH within a COT:
      By default, only one value is (pre-) configured for the set of CPE starting position for inside COT:
         The value is the default CPE starting position.
         The UE only uses the (pre-) configured default CPE starting position.
      When more than one values are (pre-) configured for the set of CPE starting position for inside COT:
         One of these values is the default CPE starting position.
         The UE uses the same method for using CPE for the case when the UE performs Type 1 channel access to initiate a COT for PSCCH/PSSCH transmission.
      FFS: Whether to support that CPE can be transmitted between any two consecutive SL transmissions between COT initiator and responder, to reduce the gap between two transmissions so that it does not exceed 16 μs, the CPE is selected from the CPE(s) (pre-) configured for PSCCH/PSSCH within a COT.
Thus, the further UE in the embodiments may correspond to the UE that starts transmitting within a shared COT. Furthermore, the extension of the transmission in the embodiments may correspond to the CP (Cyclic Prefix) extension (CPE).
The UE is to extend the transmission into the guard duration so as to transmit during a predefined time duration starting at the beginning of the guard duration,
   According to RAN₁ #109-e (9-20 May 2022), CP extension (CPE) is supported for NR sidelink operation in a shared channel. According to RAN₁ #113 (22-26 May 2023), a set of one or more candidate CPE starting position(s) that can be used for PSCCH/PSSCH transmission within a COT (for the case of sharing a COT) and outside a COT (for the case of initiating a COT) is separately (pre-) configured per resource pool based on the predefined set of all candidate CPE starting positions. For the case of sharing a COT, the CPE occurs after LBT gap for type 2A/2B/2C.
Thus, the extension of the transmission in the embodiments may correspond to the CP (Cyclic Prefix) extension (CPE).
The predefined time duration selected such that a remaining duration of the guard duration is sufficient to allow the further UE to perform a predefined channel access procedure, CAP, before accessing the shared COT.
   According to RAN₁ #113 (22-26 May 2023), if a responding UE shares a channel occupancy initiated by a COT initiating UE using Type 1 SL channel access procedure on a channel, the responding UE may transmit a SL transmission that follows a SL transmission by the COT initiating UE after a gap as follows:
      If the gap is at least 25 μs, the responding UE can transmit the SL transmission on the shared channel after performing Type 2A SL channel access procedures.
      If the gap is equal to 16 μs, the responding UE can transmit the SL transmission on the shared channel after performing Type 2B SL channel access procedures.
      If the gap is up to 16 μs and the transmission is limited to 584 μs, the responding UE can transmit the SL transmission on the channel after performing Type 2C SL channel access.
   According to RAN₁ #113 (22-26 May 2023), when UE performs Type 2 channel access to start transmitting within a shared COT (to be further studied and down-selected in RAN₁ #114):
      Alt. 1: Use the method for using CPE for the case when UE performs Type 1 channel access to initiate a COT for PSCCH/PSSCH transmission.
      Alt. 2: Use only the (pre-) configured default CPE starting position.
      Alt. 3: use CPE to make the gap smaller or equal 16 μs
      Alt. 4: others
Thus, the remaining duration of the guard in the embodiments may correspond to the gap in the agreements. The further UE in the embodiments may correspond to the responding UE, which performs a predefined CAP which corresponds to the Type 2A, 2B or 2C channel access procedure in the agreement.
In case a UE performs Type 1 channel access to initiate a COT for a transmission, and in case multiple CPE candidate positions exist, the procedure on how to select a particular CPE starting position has to be defined.
   According to RAN₁ #114 (21-25 Aug. 2023), when the UE performs Type 1 channel access to initiate a COT for PSCCH/PSSCH transmission, in the agreed Scheme 2 from RAN₁ #113, a CPE starting position is randomly selected among one or multiple CPE starting candidate positions (pre-) configured per priority of the PSCCH/PSSCH transmission. The priority level is based on the L1 priority.
Thus, the condition for selecting a certain CAP type being a priority in the embodiments may correspond to the priority level used for selecting one or more multiple CPE starting positions belonging to a certain channel access procedure, CAP.

### General

Embodiments of the present invention have been described in detail above, and the respective embodiments and aspects may be implemented individually or two or more of the embodiments or aspects may be implemented in combination.

It is noted that the inventive approach is not limited to CGs or DGs. In accordance with other embodiments, a grant may be less than a CG or DG, or it may just be a broad kind of resource coordination, e.g., which subband or subchannel to use or to avoid.

In accordance with embodiments, the wireless communication system may include a terrestrial network, or a non-terrestrial network, or networks or segments of networks using as a receiver an airborne vehicle or a space-borne vehicle, or a combination thereof.

In accordance with embodiments of the present invention, a user device comprises one or more of the following: a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, a mobile terminal, or a stationary terminal, or a cellular IoT-UE, or a vehicular UE, or a vehicular group leader (GL) UE, or a sidelink relay, or an IoT or narrowband IoT, NB-IoT, device, or wearable device, like a smartwatch, or a fitness tracker, or smart glasses, or a ground based vehicle, or an aerial vehicle, or a drone, or a moving base station, or road side unit (RSU), or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

In accordance with embodiments of the present invention, a network entity comprises one or more of the following: a macro cell base station, or a small cell base station, or a central unit of a base station, an integrated access and backhaul, IAB, node, or a distributed unit of a base station, or a road side unit (RSU), or a remote radio head, or an AMF, or an MME, or an SMF, or a core network entity, or mobile edge computing (MEC) entity, or a network slice as in the NR or 5G core context, or any transmission/reception point, TRP, enabling an item or a device to communicate using the wireless communication network, the item or device being provided with network connectivity to communicate using the wireless communication network.

Although some aspects of the described concept have been described in the context of an apparatus, it is clear that these aspects also represent a description of the corresponding method, where a block or a device corresponds to a method step or a feature of a method step. Analogously, aspects described in the context of a method step also represent a description of a corresponding block or item or feature of a corresponding apparatus.

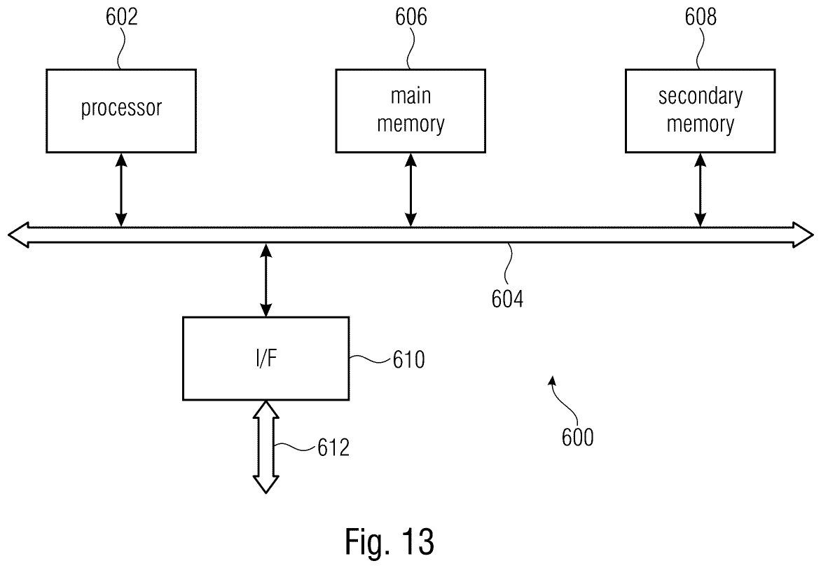

Various elements and features of the present invention may be implemented in hardware using analog and/or digital circuits, in software, through the execution of instructions by one or more general purpose or special-purpose processors, or as a combination of hardware and software. For example, embodiments of the present invention may be implemented in the environment of a computer system or another processing system. FIG. 13 illustrates an example of a computer system 600. The units or modules as well as the steps of the methods performed by these units may execute on one or more computer systems 600. The computer system 600 includes one or more processors 602, like a special purpose or a general-purpose digital signal processor. The processor 602 is connected to a communication infrastructure 604, like a bus or a network. The computer system 600 includes a main memory 606, e.g., a random-access memory, RAM, and a secondary memory 608, e.g., a hard disk drive and/or a removable storage drive. The secondary memory 608 may allow computer programs or other instructions to be loaded into the computer system 600. The computer system 600 may further include a communications interface 610 to allow software and data to be transferred between computer system 600 and external devices. The communication may be in the from electronic, electromagnetic, optical, or other signals capable of being handled by a communications interface. The communication may use a wire or a cable, fiber optics, a phone line, a cellular phone link, an RF link and other communications channels 612.

The terms “computer program medium” and “computer readable medium” are used to generally refer to tangible storage media such as removable storage units or a hard disk installed in a hard disk drive. These computer program products are means for providing software to the computer system 600. The computer programs, also referred to as computer control logic, are stored in main memory 606 and/or secondary memory 608. Computer programs may also be received via the communications interface 610. The computer program, when executed, enables the computer system 600 to implement the present invention. In particular, the computer program, when executed, enables processor 602 to implement the processes of the present invention, such as any of the methods described herein. Accordingly, such a computer program may represent a controller of the computer system 600. Where the disclosure is implemented using software, the software may be stored in a computer program product and loaded into computer system 600 using a removable storage drive, an interface, like communications interface 610.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate or are capable of cooperating with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier. In other words, an embodiment of the inventive method is, therefore, a computer program having a program code for performing one of the methods described herein, when the computer program runs on a computer.

A further embodiment of the inventive methods is, therefore, a data carrier or a digital storage medium, or a computer-readable medium comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device, for example a field programmable gate array, may be used to perform some or all of the functionalities of the methods described herein. In some embodiments, a field programmable gate array may cooperate with a microprocessor in order to perform one of the methods described herein. Generally, the methods are preferably performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A user device, UE, for a wireless communication network, like a 3^{rd} Generation Partnership Project, 3GPP, network,
wherein the UE is to perform a sidelink, SL, communication using a channel comprising resources from an unlicensed spectrum,
wherein the UE is to occupy the channel within a channel occupancy time, COT, and share the COT with a further UE, wherein the COT has a first part and a second part, the first part of the COT and the second part of the COT being separated by a guard duration,
wherein the UE is to perform a transmission over the SL during the first part of the COT,
wherein the second part of the COT is used by the further UE to perform a transmission over the SL, and
wherein the UE is to extend the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

2. The user device, UE, of claim 1, wherein the UE is to extend the transmission into the guard duration by taking or copying content from a predefined portion of the first part of the COT or the first part of the transmission, e.g., from a beginning of a last transmission symbol following a cyclic prefix, CP, or an extended cyclic prefix of data in the last transmission symbol.

3. The user device UE of claim 2, wherein the last transmission symbol comprises one or more of:
an Automatic Gain Control, AGC, symbol,
a Demodulation Reference Signal, DMRS,
a data channel, e.g., a Physical Sidelink Shared Channel, PSSCH,
a control channel, e.g., a Physical Sidelink Control Channel, PSCCH,
a feedback channel, e.g. a Physical Sidelink Feedback Channel, PSFCH.

4. The user device, UE, of claim 1, wherein the guard duration has a length of one or more of the following:
a CP length,
an extended CP, ECP, length,
an OFDM symbol length,
a multiple of the length of an OFDM symbol, e.g., ½ or twice the length of an OFDM symbol,
a number of OFDM symbols,
an interframe space, e.g., a short interframe space, SIFS, as used in WiFi systems,
a configured or pre-configured duration defined using, e.g., microseconds.

5. The user device, UE, of claim 1, wherein the CAP is one of
a Type-1 CAP that senses the channel for a random time duration,
a Type-2A CAP that senses for two sensing slots, e.g., at the beginning and end, within a gap of at least 25 μs,
a Type-2B CAP that senses for one sensing slot of 9 μs within a gap of at least 16 μs,
a Type-2C CAP that does not sense the channel.

6. The user device, UE of claim 1, wherein the CAP type used by the UE for its transmission depends on a certain condition.

7. The user device, UE of claim 6, wherein the certain condition is one or more of:
a length of the transmission, like a size of data to be transmitted by the UE, wherein the UE is to perform an LBT if the length of the transmission is at or above a predefined threshold, and wherein the UE is not to perform an LBT if the length of the transmission is below the predefined threshold the UE,
a type of data to be transmitted, e.g., the data to be transmitted is feedback data, e.g., PSFCH or the data to be transmitted is an IUC request,
a priority of a control and/or data transmission has a certain priority.

8. The user device, UE, of claim 1, wherein the COT spans at least a first time slot comprising a plurality of symbols, the first part of the COT comprising a first number of symbols, the second part of the COT comprising a second number of symbols, and the guard duration comprising a time gap, which is located between the last symbol of the first number of symbols and the first symbol of the second number of symbols.

9. The user device, UE, of claim 8, wherein
the COT spans at least the first time slot and a second time slot, the second time slot comprising a plurality of symbols, and the first time slot comprising a further guard duration comprising a time gap, which is the last symbol in the first time slot, and/or
the UE is to extend the transmission into the subsequent guard duration and/or into the further guard duration, or
the further UE is to extend the transmission into the previous guard duration.

10. The user device, UE, of any one of claims 1 to 7, wherein the COT spans at least two time slots, each comprising a plurality of symbols, the first part of the COT comprising a first time slot, the second part of the COT comprising a second time slot, and the guard duration comprising a time gap, which is the last symbol in the first time slot.

11. The user device, UE, of claim 10, wherein
the first time slot and/or the second time slot comprises a plurality of symbols, the first part of the first time slot and/or the second time slot comprising a first number of symbols, the second part of the first time slot and/or the second time slot comprising a second number of symbols, and the first part of the first time slot and/or the second time slot comprising a further guard duration comprising a time gap, which is located between the last symbol of the first number of symbols and the first symbol of the second number of symbols, and
the UE is to extend the transmission into the subsequent guard duration and/or into the further guard duration, or
the further UE is to extend the transmission into the previous guard duration.

12. The user device, UE, of claim 1, wherein the predefined time duration is determined in μs as follows:
$$( ( \frac{1}{{2}^{μ} \times 14} ) \times 1000 ) - T {G}_{m i n}$$
with
μ numerology parameter, e.g., μ=0 for 15 kHz Sub Carrier Spacing, SCS, μ=1 for 30 KHz SCS, μ=2 for 60 KHz SCS,
TGₘᵢₙ minimum time for performing a predefined CAP before accessing the shared COT, e.g., 25 μs for a type-2A LBT or 16 μs for a type-2B LBT.

13. The user device, UE, of claim 1, wherein the duration of guard symbols decreases with an increase in the subcarrier spacing and/or bandwidth.

14. The user device, UE, of claim 1, wherein the guard duration has a duration, like a switching time, allowing the UE to switch between a transmission mode and a reception mode.

15. The user device, UE, of claim 1, wherein the UE comprise one or more of a power-limited UE, or a hand-held UE, like a UE used by a pedestrian, and referred to as a Vulnerable Road User, VRU, or a Pedestrian UE, P-UE, or an on-body or hand-held UE used by public safety personnel and first responders, and referred to as Public safety UE, PS-UE, or an IoT UE, e.g., a sensor, an actuator or a UE provided in a campus network to carry out repetitive tasks and requiring input from a gateway node at periodic intervals, or a mobile terminal, or a stationary terminal, or a cellular IoT-UE, or a SL UE, or a vehicular UE, or a vehicular group leader UE, GL-UE, or a scheduling UE, S-UE, or an IoT or narrowband IoT, NB-IoT, device, or a ground based vehicle, or an aerial vehicle, or a drone, or a moving base station, or road side unit, RSU, or a building, or any other item or device provided with network connectivity enabling the item/device to communicate using the wireless communication network, e.g., a sensor or actuator, or any other item or device provided with network connectivity enabling the item/device to communicate using a sidelink the wireless communication network, e.g., a sensor or actuator, or any sidelink capable network entity.

16. A method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
occupying the channel within a channel occupancy time, COT,
sharing the COT with a further UE, wherein the COT has a first part and a second part, the first part of the COT and the second part of the COT being separated by a guard duration,
performing a transmission over the SL during the first part of the COT, wherein the second part of the COT is used by the further UE to perform a transmission over the SL, and
extending the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT.

17. A non-transitory digital storage medium having a computer program stored thereon to perform the method for operating a user device, UE, for a wireless communication network, like a 3^{rd} Generation Partnership Project, 3GPP, network, wherein the UE is to perform a sidelink, SL, communication using a channel comprising resources from an unlicensed spectrum, and wherein the method comprises:
occupying the channel within a channel occupancy time, COT,
sharing the COT with a further UE, wherein the COT has a first part and a second part, the first part of the COT and the second part of the COT being separated by a guard duration,
performing a transmission over the SL during the first part of the COT, wherein the second part of the COT is used by the further UE to perform a transmission over the SL, and
extending the transmission into the guard duration so as to transmit during a predefined time duration starting at the beginning of the guard duration, the predefined time duration selected such that a remaining duration of the guard duration is sufficient to allow the further UE to perform a predefined channel access procedure, CAP, before accessing the shared COT,
when said computer program is run by a computer.
